(19) United States
(12) Patent Application Publication
(10) Pub. No.: US 2011/0060688 A1
(43) Pub. Date: Mar. 10, 2011

(54) APPARATUS AND METHODS FOR THE DISTRIBUTION OF DIGITAL FILES

(75) Inventor: Álvaro Fernández Gutiérrez, Barcelona (ES)

(73) Assignee: MEDIA PATENTS, S.L., Barcelona (ES)

(21) Appl. No.: 12/860,458

(22) Filed: Aug. 20, 2010

Related U.S. Application Data
(63) Continuation-in-part of application No. 12/761,273, filed on Apr. 15, 2010.
Application No. 12/761,273 is a continuation of application No. PCT/EP2008/009616, filed on Nov. 13, 2008.

(30) Foreign Application Priority Data
Nov. 23, 2007 (ES) P200703089

(51) Int. Cl. G06F 21/00; G06Q 30/00

(52) U.S. Cl. 705/55; 705/14.73

(57) ABSTRACT

Processes and apparatus for the on-line distribution of digital files with advertisements, advertisement management systems, digital rights management systems, and a user computing devices are provided. In some implementations, a method involves transmitting a digital file to a computing device upon receiving a request originating from the computing device to download the digital file to the computing device, the digital file having a set of executable instructions and transmitting one or more advertisements associated with the digital file to the computing device. In one implementation the set of executable instructions when executed in the computing device are useable to detect if one or more of the associated advertisements have not been received or properly played in the computing device. In one implementation the set of executable instructions are also useable to delay or to prevent or to inhibit full execution of the digital file in the computing device upon detecting that one or more of the associated advertisements have not been received or properly played in the computing device.

### CROSS-REFERENCE TO RELATED APPLICATIONS

This application is a continuation-in-part of and claims the benefit and priority to U.S. patent application Ser. No. 12/761,273 filed Apr. 15, 2010, which relates to and claims the benefit and priority to PCT Application No. PCT/EP2008/009616 filed Nov. 13, 2008, which relates to and claims the benefit and priority to Spanish Patent Application No. P200703089 filed Nov. 23, 2007.

### FIELD

The invention relates to processes for the on-line distribution of digital files and advertisements.

### BACKGROUND

The trend offered today on the market for playing audiovisual content with intellectual property rights, such as movies or music for example, is aimed at developing a series of Digital Rights Management or DRM technologies such that users pay for viewing the contents of greater interest without receiving advertising in the contents. The so-called VOD (Video On Demand), virtual stores which sell the content on the Internet, and also IP payment or PPV (Pay_Per_View) televisions in which a user pays to see certain content, are based on this principle.

Content producers and distributors using this payment per content principle have been very negatively affected with the creation of P2P (Peer_to_Peer) networks, which allow exchanging files with content free of charge without the user who sees the content paying any price at all. There are a number of P2P networks, such as eMule, Ares Galaxy or BitTorrent for example, which have become very wide-spread. P2P transmissions are systems using the upload bandwidth of each user receiving a file for sharing the file. Thanks to this upload bandwidth, each user receiving data of a file sends to other users these same data. A network of users exchanging data forming the file with one another, instead of each user downloading the entire file from a provider site, is thus formed.

The owners of the intellectual property rights of the files distributed in P2P networks have initiated a number of legal actions in different countries with the intention to shut down the P2P networks. To prevent the shut-down of the servers managing P2P networks by the police or other official or judicial organisms, P2P networks have evolved in two ways: on a technological way and on a legal way.

From a technological point of view, “pure” P2P networks have emerged in which there are no servers that can be shut down by means of a judicial or police action. These new networks use new technologies, such as DHT or Distributed Hash Tables for example, which allow networks to operate without a server, whereby there is not a single central point where the police can stop the operation of the network. In order to stop a pure P2P network it is necessary to paralyze all its nodes or most of them, which greatly hinders the effectiveness of legal actions aimed at shutting down these networks.

From the legal point of view, new P2P networks have emerged such as Bit Torrent, the servers of which contain no file with intellectual property rights, rather they only contain “bit torrent” files with information on the points of the P2P network from which parts of a file with intellectual property rights can be downloaded, and it is debatable that the supply of a simple bit torrent file is illegal.

The discussion regarding the legality of P2P networks must further take into account legal uses of the networks, such as downloading files the owners of which have agreed to the download: demo software versions, open code software, content under the Creative Commons license and the like. For these reasons the current legal status of P2P networks is not altogether clear and furthermore changes depending on the country.

In opposition to this pay per content system which, as previously mentioned, has been very negatively affected by the emergence of P2P technologies, is the conventional television which broadcasts unrestrictedly and in which the users do not have to pay to see the content. Conventional television applies an advertising system in which the television channel offers advertisers a space that is reserved on its broadcasts to insert advertisements, and the cost of each advertisement depends on the duration thereof and on the expected audience for the time it will be broadcast. In addition, predictions relating to the type of audience, i.e. to the profile of the expected spectator, allow adjusting the type of advertisement for each channel and time slot. This same advertising system is currently used in digital cable television, with the difference that by having a large number of thematic channels, it is possible to more accurately predict the profile of the typical spectator of each channel.

The broad diffusion of the Internet network and the emergence of P2P networks have not significantly affected this conventional television advertising system, which continues to operate without suffering the income losses that are affecting the sale of music and movies in CD and DVD formats. It therefore seems that there is a rather widespread and accepted social behavior consisting of watching commercial television channels that insert advertising in their contents to finance the broadcasts and that this model is more widely accepted by users than the pay per content system.

Applying the principles of the conventional television advertising system to the field of Internet downloads, i.e. a user access audiovisual content in exchange for watching advertising, is of great interest. As previously mentioned, this system is more widely accepted socially than the pay per view system and allows suitably compensating the intellectual property rights owners.

However, in order for such a system applied to Internet downloads to work satisfactorily, technical solutions are necessary which allow on one hand reaching a large diffusion of the audiovisual contents offered by Internet and, on the other, allowing swift participation of the different participants: download sites, advertisers, users and intellectual property rights owners. Both conditions are necessary for such a system applied to Internet downloads to be sufficiently efficient and to be implemented in practice.

Companies advertising their products or services on the Internet attempt for their webpage to be found as easily as possible by a user navigating on network and interested in the products. A known method for attaining this objective consists of advertising the products on content webpages attracting users interested in a specific topic. These content webpages can be, for example, thematic pages on videogames, film, music, computer programs, etc. The advertisements are arranged in the form of advertising inserts including a link, such that when a user clicks on one of the links, he/she is redirected to the webpage of the selling company that has placed the advertisement and such company pays the content webpages a fee in accordance with the number of clicks made on the links.

U.S. Pat. No. 5,948,061 describes an application of this method in which the advertisers deliver to a server its advertisements in the form of advertising inserts so that it chooses which webpages are the most suitable for hosting each advertising insert. The webpages ascribed to this system contain a reference putting the browser of a user who visits the webpage in contact with the server, and then the latter sends to the browser an advertising insert, for example in the form of an advertising band or banner, for the browser to display it on the user's computer screen. Selection of the advertising insert sent to the browser is based on the information that the user's browser delivers to it, including an identification of the webpage that the user has visited and information about the user (such as the Internet address from which the browser acts and other data that the user has agreed to communicate). If the user clicks on the advertising insert, the browser again contacts the server and the server redirects it to a webpage of the advertiser.

A more evolved application of this method, which is more effective in relation to the way of organizing the relationship between the selling companies of products or services and the content webpages, and also in relation to the way of technically implementing the inclusion of advertising inserts in webpages and the fee for the clicks made, is the AdSense system of the Google search engine described in US Patent Applications published as US200410093327 and US200410059708. This system allows a website to include advertising of several advertisers and to receive a fee for it. The AdSense system analyzes the content of the webpages which are to host advertising inserts and decides which webpages are the most suitable for each advertising insert. The advertising inserts contain a link to the advertiser's webpage. Every time a user clicks on one of these advertising inserts, the owner of the webpage hosting the advertising insert obtains a fee from the advertiser. The AdSense system has the significant advantage of allowing companies to advertise on webpages the content of which is related to its products and which will therefore be the webpages visited the most by users who are potentially interested in the products. However, it has the drawback that it does not effectively allow preventing fraudulent clicks occurring when the owners click on their own webpage advertising inserts for the sole purpose of increasing the fee that will be paid by the advertiser. Another type of fraudulent clicks consists of a company dedicated to repeatedly clicking an another company's advertising insert with the sole purpose of quickly reaching the maximum budget established for the advertising insert and to thus cause the automatic deactivation thereof. The problem with the fraudulent clicks very negatively affects both advertisers, who pay for useless clicks, and the owners of the webpages hosting the advertising inserts. In fact, many advertisers reject this system or are willing to pay very little for the advertising inserts. To solve this problem within the AdSense system, it would be necessary to detect the situations in which a click is repeated several times from a single IP address and to provide a process for deciding whether or not they are fraudulent clicks. For reasons that are obvious to a person skilled in the art, such a solution complicates the operation of the system.

Another drawback of the AdSense system is that it does not respond to the specific problems of downloading digital files with intellectual property rights.

U.S. Pat. No. 6,363,356 describes a system offering a solution that can be applied to the online distribution of software with the option of testing it before buying it. This system allows the advertiser to only pay for the clicks that have effectively resulted in a software sale. To that end, when a user clicks on an advertising insert and is redirected to the webpage of the software company, the URL (Uniform Resource Location) address of the webpage that hosted advertising insert is included in the redirectioning. This information is received and stored by the software company's webpage server and is added to the digital file when the user downloads it. Therefore, when the user contacts the software company's webpage again to buy a use license for the software, it is possible to know on which webpage the advertising insert that generated the purchase of the license was located.

This system disclosed in U.S. Pat. No. 6,363,356 has not been extended because it has several drawbacks. A first drawback consists of the fact that it is not designed to be applied globally: each advertising company must implement its own method to relate itself with content webpages and to include advertising inserts in them. A second drawback of this system is that in order to add the reference Web URL address to the downloaded file, the file is encapsulated in a wrapper and the information is added to the wrapper. The user does not directly download the digital file that he had selected, but rather the wrapper containing it. This requires performing a recompilation process before downloading and therefore a wait time is introduced that is too long for the standard download time scale on the Internet. This is the main reason that this system was never developed in practice. A third drawback of this system is that it does not provide for the case in which the download is direct, i.e. directly from a content webpage offering downloads, such as the webpage www.tucows.com for example.

As has been seen, the known technical solutions are not entirely satisfactory. For this reason, current audiovisual contents distribution systems only offer the option of paying to see the content, with the aforementioned consequence that many users choose to download the contents from the P2P networks, whereby the intellectual property rights owners receive no fee.

U.S. Pat. No. 7,152,091 discloses an advertising method applied to downloading contents on the Internet consisting of showing advertising in a user's browser while the user downloads a content. The download is cut off if the user interrupts the playing of advertising in the user's browser. This method has the drawback that it is rather ineffective in practice because users are not used to being in front of a computer during the time a download takes. With the currently available technology for most users, downloading a 400 Mbyte video takes approximately four hours, whereby it is common for a user to launch a download and to leave to do other things. In addition, the method described in U.S. Pat. No. 7,152,091 does not allow controlling that the user actually sees the advertisements. Even in the event that the user remains in front of the computer, he/she can reduce the browser window in which the advertisements are shown and continue doing other things in the computer.

### SUMMARY OF THE DISCLOSURE

According to one or more implementations a method is provided comprising: transmitting a digital file to a computing device upon receiving a request originating from the computing device to download the digital file to the computing device, the digital file comprising a set of executable instructions; and transmitting one or more advertisements associated with the digital file to the computing device; the set of executable instructions when executed in the computing device useable to detect if one or more of the associated advertisements have not been received or properly played in the computing device. In one implementation the set of executable instructions are also useable to delay or to prevent or to inhibit full execution of the digital file in the computing device upon detecting that one or more of the associated advertisements have not been received or properly played in the computing device.

According to one or more implementations a software application is provided that is downloadable from a first site to a user computing device, full or unrestricted use of the software application in the user computing device requiring one or more advertisements associated with the software application to be played in the computing device, the software application comprising a module having executable instructions that when executed in the user computing device 1) accesses data related to the one or more advertisements from within the computing device or from the first site, 2) determines by use of the data if the one or more advertisements has been played in the computing device, and 3) inhibits full or unrestricted use of the software application in the computing device upon determining that less than the one or more advertisements have been played in the computing device.

According to one or more implementations a method is provided comprising: transmitting a public key to a content provider to be incorporated into a software application, the public key associated with a private key; receiving from the content provider the software application having the public key; receiving from one or more advertisers a first one or more advertisements and associating the first one or more advertisements with the software application; creating a first digital signature associated with first metadata that comprises information about the first one or more advertisements by use of the private key; transmitting to a computing device the software application having the public key; transmitting to the computing device the first one or more advertisements; and transmitting to the computing device the digitally signed first metadata.

According to one or more implementations a method is provided comprising: receiving from an advertiser a first one or more advertisements and associating the first one or more advertisements with a software application; creating a first digital signature associated with first metadata that comprises information about the first one or more advertisements by use of a private key; transmitting a public key associated with the private key and a cryptographic algorithm useable to validate the first digital signature to a content provider to be incorporated into a software application; receiving from the content provider the software application having the public key and the cryptographic algorithm; transmitting to a computing device the software application having the public key and the cryptographic algorithm; transmitting to the computing device the first one or more advertisements; and transmitting to the computing device the digitally signed first metadata.

According to one or more implementations a method is provided comprising: transmitting from a first site executable instructions to a second site for the purpose of being incorporated into a software application, the first site different from the software application manufacturer site, receiving in the first site, or a third site associated with the first site, the software application incorporating the executable instructions, transmitting from the first site or the third site the software application incorporating the executable instructions to a user computing device, transmitting from the first site and/or the third site and/or or a fourth site associated with one or both of the first and third sites, one or more advertisements associated with the software application to the user computing device, full or unrestricted use of the software application in the user computing device requiring one or more of the advertisements to be played in the computing device, the executable instructions when executed in the user computing device 1) accesses data related to the one or more advertisements from within the computing device or from the first site and/or third site and/or fourth site, 2) determines by use of the data if the one or more advertisements has been properly played in the user computing device, and 3) inhibits full or unrestricted use of the software application in the user computing device upon determining that less than the one or more advertisements has been properly played in the user computing device.

in some implementations a process for the on-line distribution of audiovisual contents involves:

an intermediary site receives digital files with audiovisual content on-line and makes a selection of referring sites suitable for offering the digital files on-line;

advertiser sites provide the intermediary site with advertisements to be shown,

the intermediary site makes a selection of the advertisements and assigns to each digital file associated advertisements;

a user accesses one of the selected referring sites on-line, which offers the digital files on-line, and downloads one of the digital files on-line;

the downloaded digital file is used in equipment in which a user wishes to play the audiovisual content of the downloaded digital file;

the equipment receives the associated advertisements which have been assigned by the intermediary site to the downloaded digital file, and the associated advertisements are shown in the equipment;

it is checked that the associated advertisements have been shown in the equipment and after having performed the check:
[i] an audiovisual content player provided in the equipment plays the audiovisual content of the downloaded digital file, and
[ii] download identifying data, comprising at least identifying data of the referring site, and play information data, comprising at least information which allows identifying the associated advertisements, are transmitted on-line to the intermediary site;

based on the identifying data of the referring site, the intermediary site performs an action to remunerate the referring site and, based on the play information data, the intermediary site performs an action to receive remuneration from the advertiser sites that had provided the associated advertisements.

In accordance with some implementations, the invention provides a first advertisement management form in which the download identifying data is combined with the digital file before it is downloaded, i.e. before the download thereof is initiated or while it is being downloaded.

In some implementations the download identifying data is combined with the digital file as files properties metadata of the digital file.

In some implementations, the associated advertisements are incorporated within the digital file before it is downloaded, whereby the equipment receives the associated advertisements as part of the downloaded digital file.

In some implementations, an advertising management system cooperating with the player is executed in the equipment so that the associated advertisements, which are associated to the downloaded digital file, are shown by the player and to prevent playing the audiovisual content of the downloaded digital file in the player if the associated advertisements have not been shown in the player.

In some implementations, once the associated advertisements have been shown in the player, the advertising management system transmits on-line to the intermediary site the download identifying data, which are incorporated within or otherwise combined with the downloaded digital file, and the play information data.

In some implementations the advertising management system also transmits on-line to the intermediary site unique identifying data of the equipment or of the user of the equipment.

In some implementations the advertising management system communicates on-line with the intermediary site, transmits information to it which allows identifying the downloaded digital file and receives from the intermediary site new associated advertisements which were not incorporated in the downloaded digital file, and the advertising management system cooperates with the player so that it shows the new associated advertisements.

In some implementations the advertising management system communicates on-line with the intermediary site, transmits information to it which allows identifying the downloaded digital file and receives from the intermediary site indications to cancel associated advertisements which were incorporated in the downloaded digital file, and the advertising management system cooperates with the player so that the advertisements which have been cancelled by the intermediary site are not shown.

In some implementations the advertising management system cooperates with the player so that, when it has finished showing one of the associated advertisements the player waits to receive an indication from the user to begin to show the following associated advertisement. Furthermore, the advertising management system preferably cooperates with the player so that the latter does not show the audiovisual content of the downloaded file if the time elapsed between the moment in which the player has finished showing one of the associated advertisements and the moment in which the user indicates to the player to begin to show the following associated advertisement exceeds a certain threshold.

In one or more implementations to carry out the distribution of digital files in which the intermediary site provides on-line to the referring sites links to be installed in the referring sites, such that when a user activates one of the links in one of the referring sites, the user is redirected to a download site to download, from the download site, the digital file; and the download identifying data, which are transmitted on-line to the intermediary site after having shown in the equipment the associated advertisements, comprise identifying data of the download site.

In some implementations a download management application is executed in the download site and receives the identifying data of the referring site and, when the user is redirected to the download site to download the digital file, the download management application incorporates within the digital file the identifying data of the referring site.

In some implementations the download management application which is executed in the download site incorporates within the digital file as the download data, in addition to the identifying data of the referring site, the identifying data of the download site.

According to some implementations other advertisement management forms, such as, for example, one in which in order to download the digital file, a browser of the equipment accessing a download site on-line is used; the download site sends the associated advertisements to the browser so that the browser shows them in the equipment and the download site does not allow the download of the file to be performed until the advertisements have been shown in the browser.

In some implementations the download site sends to the intermediary site on-line the download identifying data and the play information data.

In some implementations a digital rights management system, checking that the associated advertisements have been shown by the browser of the equipment and which cooperates with the player to prevent playing the audiovisual content of the downloaded digital file if the associated advertisements have not been shown in the browser, is executed in the equipment.

In some implementations the digital rights management system cooperates with the player to limit the number of times that the audiovisual content of the downloaded digital file can be played, and/or the time during which the audiovisual content can be played since the associated advertisements were shown in the browser.

In some implementations once one of the associated advertisements has been shown in the browser, the following associated advertisement is not shown in the browser as long as the user does not indicate, by interacting with the equipment, that the following associated advertisement should be shown.

In some implementations the download site does not authorize the download of the digital file if the time elapsed between the moment in which the browser has finished showing one of the associated advertisements and the moment in which the user interacts with the equipment to indicate that the following associated advertisement should be shown exceeds a certain threshold.

In some implementations the intermediary site makes an automatic selection of the advertisements provided by the advertiser sites and assigns them to each digital file. According to one implementation, the intermediary site receives on-line, together with the digital files, information about the audiovisual content category of each digital file, and the intermediary site is provided with an advertisement auction management module in which the different advertiser sites offer on-line a price for their advertisements for each audiovisual content category.

In some implementations the intermediary site receives on-line the digital files from proprietary content sites and, after the audiovisual content of the downloaded digital file has been played in the equipment, the intermediary site receives on-line the play information data further comprising information which allows identifying the downloaded digital file, and the intermediary site performs an automatic action to remunerate the proprietary content site from which it had received the downloaded digital file.

Some implementations also relate to advertisement management systems and to the digital rights management systems, which have the functionalities described above in reference to the processes according to the invention. Some implementations also relate to an audiovisual content player incorporating any of these systems or methods.

### BRIEF DESCRIPTION OF THE DRAWINGS

Other advantages and features of the invention will be observed based on the following description in which some embodiments of the invention are described, with a non-limiting character, referring to the attached drawings.

FIG. 1 shows a block diagram illustrating an exemplary system for applying the processes according to some implementations of the present invention.

FIG. 2 shows a block diagram illustrating at a high level an algorithm executing a download application in a download site from which a file is downloaded after a link to the file has been activated in a referring site, according to a system of FIG. 1.

FIG. 3 shows a block diagram illustrating an algorithm executing an advertising management system in a user's equipment.

FIG. 4 shows a block diagram illustrating an algorithm executing an advertising management system in a user's equipment.

FIGS. 5 and 6 respectively illustrate the structure in one implementation of a file with audiovisual content which is downloaded by a user and the structure of an advertisement file which is transmitted by an intermediary site to update the advertisements which to be played together with the audiovisual content.

FIG. 7 shows a block diagram illustrating another exemplary system for applying the processes according to some implementations of the present invention.

FIG. 8 shows a block diagram illustrating another exemplary system for applying the processes according to some implementations of the present invention.

FIG. 9 shows a block diagram illustrating another exemplary system for applying the processes according to some implementations of the present invention.

FIG. 10 shows a block diagram illustrating another exemplary system for applying the processes according to some implementations of the present invention.

FIG. 11 shows a block diagram illustrating another exemplary system for applying the processes according to some implementations of the present invention.

### DETAILED DESCRIPTION

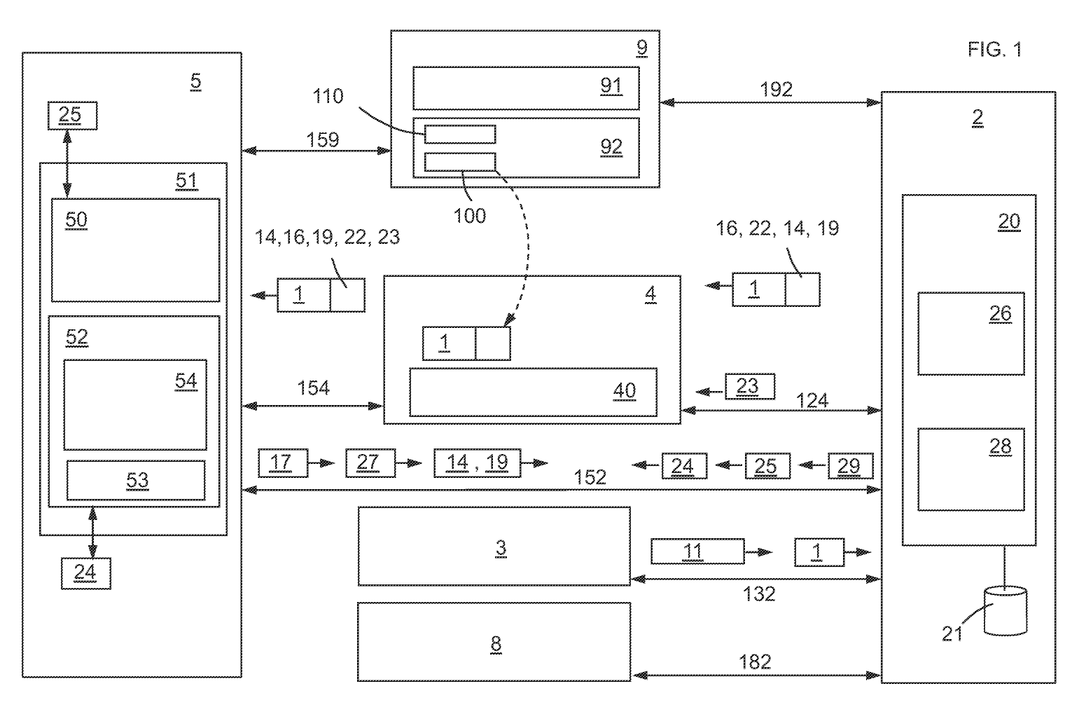

The block diagram of FIG. 1 schematically shows an exemplary system of applying processes according to the present invention. In this example, the data network is the Internet. The system is formed by a user's equipment 5, an intermediary site 2, a plurality of referring sites 9 associated to the intermediary site 2, a plurality of proprietary content sites 3, advertiser sites 8 and one or several download sites 4. In one implementation all these sites 2, 3, 4, 8 and 9 are Internet websites. For greater clarity in the explanation, a single referring site 9, a single proprietary content site 3, a single advertiser site 8 and a single download site 4 have been shown. However, the system and the process according to the invention are especially advantageous when a large number of referring sites 9 are involved because the greater the number of the referring sites 9 the greater the number will be of Internet users attracted by such sites and therefore the greater will be the number of file downloads.

In the different processes according to the invention, the different sites 2, 3, 4, 8, 9 and the user's equipment 5 can establish among one another the on-line communications shown in FIG. 1: 152, 154, 159, 192, 132, 182 and 124.

The communications between the different sites of FIG. 1 can be carried out using different communication protocols or technologies such as FTP (File Transfer Protocol), HTTP (Hypertext Transfer Protocol), Web services, SOAP (Simple Object Access Protocol) objects, TCP/IP (Transmission Control Protocol/Internet Protocol) connections or any other method of communication between networks.

The example shown in FIG. 1 illustrates a case in which a digital file 1 containing, for example, music, video, images or text in digital format, which is protected by copyright and which can be played in a user's equipment 5, is downloaded. In this example, the equipment 5 is a computer with a connection to Internet. However, the invention can also be applied to other equipment that can be connected to a data network, such as mobile telephones or digital players with the capacity to connect to a data network for example. Returning to the example, the computer 5 has an operating system 51 in which a content player 52 capable of playing audiovisual content of a file 1 in a screen or window 54 is installed and which is equipped with an advertising management system 53.

The advertising management system 53 is a control system which in some implementations is capable of detecting that the audiovisual contents of the files 1 are protected by intellectual property rights and which sees to it that, along with playing the audiovisual content of each downloaded file 1, the advertisements associated thereto are shown. Some functionalities of an advertising management system 53 according to various implementations are described below.

The different steps of the processes according to example illustrated in FIG. 1, as well as the different logic elements and materials which allow applying the processes, are described below.

A proprietary content site 3 is a site of a company, or of a person, who owns or otherwise possesses the rights of audiovisual contents of files 1 and who is interested in obtaining advertising earnings derived from playing the audiovisual contents of the files 1. The proprietary content site 3 is registered on-line 132 in the intermediary site 2. During this registration process 132, the proprietary content site 3 introduces its identifying data such as name, address, e-mail, etc., for example, and sends the files 1 to the intermediary site 2 so that the intermediary site 2 can distribute it. The intermediary site 2 has an intermediation application 20, for example with a Web interface, which allows performing the registration process and storing the registration information of the proprietary content site 3 in a database 21.

During the registration process, the proprietary content site 3 may also provide to the intermediary site 2 commercial information 11 related to the file 1. The commercial information includes information on the type of content which will allow the intermediary site 2 to select the most suitable advertising categories for each type of content, such as the name of the file, the name of the parties, the type of movie for example, etc. It may also include a series of key words associated to each file 1 indicating which is the content of the file and which will be used by the intermediary site 2 to select suitable referring sites 9 for each file 1, as will be seen below. The intermediary site 2 also stores this information 11 in the database 21, and can modify it so that it adapts to its own criteria, such as for example not advertising content for adults on Webs which are not classified as adult webs, or any other type of modification which the intermediary site 2 considers suitable to perform in the description of the files.

The intermediary site 2 preferably incorporates in each file 1 an identifier 16 which allows the intermediary site 2 to uniquely identify each file. Based on the identifier 1, the intermediary site 2 accesses its database 21 and consults the information associated to each file. For example, the identifier 16 can be a GUID (Globally Unique Identifier), which is a reference number randomly generated by the application and which in practice is unique because the probabilities that the same number is assigned twice are very small. GUID-based techniques are known by a person skilled in the art and it is therefore not considered necessary to explain them in greater detail.

The intermediary site 2 optionally incorporates directly in the files 1 advertisements 22 which must be shown when the audiovisual content of the files 1 is played. As will be seen below, it also provides that the download site 4 inserts advertisements 23 in the files 1, and that the intermediary site 2 directly sends advertisements 24 to the computer 5 in which the audiovisual content of the files 1 is played.

The intermediary site 2 reaches agreements with a series of referring sites 9 and download sites 4 which are interested in participating in the on-line distribution of files 1 in exchange for receiving a commission or percentage of the advertising earnings which are generated. As previously stated, FIG. 1 shows a single referring site 9 and a single download site 4 to facilitate the description. The function of the referring site 9 is to attract a certain group of users who are navigating on the Internet and who are interested in the content 91 offered by the referring site 9. The users who visit a webpage of the referring site 9 can see in the webpage advertising inserts 110 and download the files 1 by clicking on the respective links 100.

The intermediary site 2 makes a selection of the referring sites 9 which can advertise the different files 1. To that end, candidate sites to being referring sites 9 are communicated on-line 192 with the intermediary site 2 and perform an on-line registration process consisting of identifying (e.g., name, address, telephone, e-mail, etc.) and communicating the URL address which allows locating it on the Internet. During the registration process of the referring site 9, the intermediary site 2 can optionally request that a series of words or descriptions which are used to describe the content 91 of the referring site 9 are introduced.

In some implementations, when the referring site 9 finishes the registration process in the intermediary site 2, the intermediary site 2 supplies it with the code of an advertising insert and link management application 92 which the referring site 9 adds to its own webpage, for example by copying (Control+C in Microsoft® Windows) from the webpage of the intermediary site 2 the text of the code and pasting it (Control+V in Microsoft® Windows) in the HTML content of a webpage of the referring site 9. The advertising insert and link management application 92 can be, for example, a code in Javascript, PHP or ASP.NET language, which communicates with the intermediary site 2 by means of Web services (collection of protocols and standards used to exchange data between websites through the Internet). The advertising insert and link management application 92 also allows the intermediary site 2 to modify the advertising inserts 110 and the links 100 for the purpose of updating them. As will be seen below, this allows optimizing the efficacy of the referring sites 9 in terms of the number of file downloads and number of sales. The programming of the advertising insert and link management application 92 is within the scope of a person skilled in the art, as it forms part of the basic knowledge of any programmer who knows the operation of the Web services. It is therefore not considered necessary to explain them in further detail.

In some implementations, when the advertising insert and link management application 92 is executed in a webpage of the referring site 9, it shows the advertising inserts 110 together with the links 100. When a visitor of the webpage of the referring site 9 activates one of the links 100, the file 1 is downloaded in the visitor's computer 5.

In some implementations, once the referring site 9 has been registered, the intermediary site 2 analyzes the referring site 9 to check that the advertising insert and link management application 92 works properly and also to analyze the content 91 of the referring site 9. The intermediary site 2 counts the number of times that each word appears in the content 91 of the referring site 9, selects those words which in the referring site 9 are greater in number than certain percentage and stores this content information of the referring site 9 in its database 21. The intermediary site 2 then chooses the most suitable files 1 depending on the content 91 of the referring site 9. For example, a referring site related to black and white films will be especially suitable for downloading black and white movies, whereas a referring site related to rock music will be suitable for of rock music downloads. In order to choose which are the most suitable files 1 for each referring site 9, the intermediary site 2 compares the content information of the referring site 9 it has stored in its database 21 with the commercial information 11 of the files 1 provided by the proprietary content site 3, and chooses, for each referring site 9, the files 1 having a higher degree of coincidence with the content information of the referring site 9.

In order to optimize the number of file downloads 1 and its possible advertising earnings, the intermediary site 2 can vary the links 100 of each referring site 9 and perform a statistical follow-up of which generate more downloads and more advertising earnings. In some implementations the intermediary site 2 controls file downloads 1 in each referring site 9 and the advertising earnings generated by each file. This statistical information is stored in the database 21 of the intermediary site 2. The intermediary site 2 can thus establish which of the files 1 have the highest probability of being downloaded and played by relating the historical advertising earnings with the selected key words of each referring site 9. For example, by multiplying the advertising income created when the advertisements associated to the audiovisual content of the files 1 are shown by the commission percentage that the referring site 9 will earn, and taking into account the percentage of users who download a file and subsequently play the audiovisual content of the file 1 and see the associated advertisements, the intermediary site 2 obtains a statistical estimation of the earning that each click on a link 100 or each viewing of an advertisement of a file 1 involves for the referring site 9. The intermediary site 2 can thus update the advertising inserts 110 and the associated links 100 of a referring site 9 so that they advertise and indicate the files 1 which will generate greater earnings. Another method that the intermediary site 2 can use to select the most suitable files 1 for each referring site 9 consists of choosing files similar to the most successful files on another referring site 9 having a similar content 91. Evidently, a manual selection of the most suitable files 1, a manual selection being understood as a selection made by a person, is always possible, but at a high cost. This cost is preferably eliminated by using a computer program which automatically executes the described selection algorithms.

When a user uses the Internet browser 50 of the computer 5 to access a webpage of the referring site 9 containing the advertising insert and link management program 92 and activates one of the links 100, the process of downloading the file 1 associated to the link 100 is initiated from a download site 4. To that end, in some implementations each one of the links 100 contains a URL address pointing to the corresponding file 1 in the download site 4. This is schematically indicated in FIG. 1 by means of an arrow drawn with dotted lines indicating the file 1 from the link 100.

In some implementations the files 1 have previously been delivered to the download sites 4 by the intermediary site 2. In order to receive on-line 124 the files 1 provided by the intermediary site 2, the download sites 4 can use, for example, the FTP protocol. To that end, each download site 4 receives, for example, from the intermediary site 2 a user name and a password or access code authorizing him to receive files 1 from the intermediary site 2.

Preferably, as shown in the example of FIG. 1, the download sites 4 are different from the referring sites 9. This allows a user to download the files 1 from a download site 4 without the bandwidth or transmission speed of the communication of the referring sites 9 with Internet being affected by the file downloads and decreasing the access speed of the users who wish to see the content 91 of the referring sites 9. However, other set-ups of download sites 4 are possible without departing from the scope of the present invention. Therefore, for example, the download site 4 can be the actual referring site 9 if the latter has sufficient bandwidth to allow Internet users to consult its content 91 and at the same time download the files 1. Another possible set up is that the download site 4 forms part of the intermediary site 2.

In some implementations download identifying data 14, 19 are incorporated in the files 1 before the files 1 are downloaded by a user from a computer 5, or in the moment in which the download is initiated. The incorporation of this download identifying data in the files 1 can be done in different ways. An especially advantageous way of adding the data to the files 1 consists of including them as metadata of the files 1. This operation is carried out prior to the download or in the moment of the download, and can be carried out in the intermediary site 2 or partially in the intermediary site 2 and in each download site 4, as will be seen below.

The metadata of a file are data containing formal information of the file, such as for example the name, size, type of file, modification date, owner, etc. In Microsoft® Windows, these metadata can be seen in File>Properties of the Document menu in the graphic interface of the Windows applications. The location containing this metadata in the file has several fields which are currently free. In some implementations process these metadata-free fields for housing the download identifying data in them. Another solution according to the invention consists of defining new properties or metadata fields for a file, for example by using the Microsoft DSOFile.dll library, and housing the download identifying data in them.

In some implementations the download identifying data incorporated in the files 1 which are downloaded comprise at least identifying data 19 of the referring site 9 in which the user has activated the link 100 that led to the download. This identifying data 19, which includes for example the URL address of the referring site 9, allows identifying the referring site 9 to remunerate it for its participation in the event that an advertising income is generated, if the advertisements associated to playing the audiovisual content of the downloaded file 1 are shown.

Furthermore, the download identifying data also preferably comprise identifying data 14 of the download site 4 from which the file 1 is downloaded. This data 14, including for example the URL address of the download site 4, allow identifying the download site 4 to remunerate it for its participation in the event that an advertising income is generated, if the advertisements associated to playing the audiovisual content of the downloaded file 1 are shown.

In some implementations, before providing the files 1 to the download site 4, the intermediary site 2 incorporates to the files 1 all the download identifying data 14, 19 in the form of metadata of the files 1. The intermediary site 2 then delivers these files 1 to the download site 4 and also sends to the referring site 9 advertising inserts 110 in the form of text and/or images relating to the files 1 which have been sent to the download site 4, as well as the links 100 that the referring site 9 must publish on its webpage. When the advertising insert and link management program 92 of the referring site 9 receives the advertising inserts 110 and links 100, it shows them on the content webpage 91 in which it is installed. Any user accessing the referring site 9 through Internet will see the advertising inserts 110. When the user activates one of these links 100 in the referring site 9 it initiates from the download site 4 the download of the corresponding file 1, which will in some implementations incorporate the download identifying data 14, 19 in the form of metadata. This embodiment requires that the intermediary site 2 delivers to the download site 4 each one of the files 1 with all download identifying data incorporated, i.e. with the identifying data 14, 19. If, for example, there are 10,000 referring sites advertising a file 1 having a size of 50 Megabytes, the intermediary site must incorporate the download identifying data in 10,000 files and send each one of these files to the download site 4, which must store them all, thus taking up a space of 500 gigabytes.

In some implementations, the identifying data 19 of the referring site are incorporated in the files 1 in the moment of the download. To that end, when a user activates one of the links 100 in the referring site 9, the link 100 includes in some implementations a URL address to redirect to the download site 4 and it also includes in some implementations the actual URL address of the referring site 9 so that it can be transmitted to the download site 4. This can be done, for example, by passing the information of the URL address of the referring site 9 as a parameter in the URL address it takes from the webpage of the referring site 9 to the webpage of the download site 4. In some implementations in the download site 4 a download management application 40 receiving the identifying data 19 of the referring site 9 is executed and incorporates them as metadata to the file 1 to be downloaded by the user. An embodiment of this process is explained below.

A user accesses referring site 9 number 5,000 and activates link 100 to download the file 1. The link 100, which has been prepared by the intermediary site 2 and installed in the referring site 9 by the advertising insert and link management program 92, contains the following URL address:

http://www.download-site.com/referring-site-5000/f1.mp4

The first part “www.download-site.com” identifies the URL address of the download site 4, the second part “referring site-5000” is a parameter identifying the URL address of referring site number 5,000, and the last part f1.mp4 identifies the file 1 to be downloaded.

When the download site 4 receives the download request to download the file 1, the download management program 40 which is executed in the download site 4 examines this URL address, detects that it comes from referring site 9 number 5,000 and in some implementations adds the following information to the metadata of the file 1 as identifying data 19 of the referring site 9:

URL9=http://www.referring-site-5000.com
wherein URL9 is a label which has been defined in the metadata of the file 1 by the intermediary site 2 to host the URL address of the referring site 9. The download management application 40 copies the URL address of the referring site 9 http://www.referring-site-5000.com in the URL9 label.

As a result of this preferred embodiment, the intermediary site 2 need only deliver to the download site 4 a single copy of each file 1 without needing to send a plurality of files 1 or to include in the download identifying data the identifying data 19 of the referring site 9. Returning to the numerical example explained above, it can be seen that by applying this preferred embodiment the intermediary site 2 sends to the download site 4 a single file with a size of 50 megabytes (instead of 10,000 files with a size total of 500 gigabytes).

When the download site 4 receives a visit that was redirected from a link 100 of a referring site 9, the download management application 40 of the referring site 4 in some implementations has different copies of the corresponding file 1 that was delivered by the intermediary site 2, and copies the identifying data 19 of the referring site 9 in the URL9 label of the metadata of one of the copies of the file 1. Once the data 19 has been introduced in the metadata of the copy of the file 1 the latter is downloaded in the user's computer 5.

The reason that the download management application 40 may have several copies of the files 1 that are downloaded prepared is that while one of the files is being downloaded, a process which can last several seconds or several minutes, the properties of the file cannot be modified so as to respond to a second download request which arrives before the file is fully sent to the first user who is downloading it. If the download management application 40 modifies the metadata of a file which is being downloaded to include the referring site for a second download before the first download ends, it is very likely that the first download will fail and a file with mistaken data will be downloaded.

If the size of the file 1 is small, the download management application 40 can make a copy in the very moment of the download request, modify the metadata of the copy and send the file with the updated metadata. If the size of the file is large, the download management application 40 would take several seconds or minutes to make a copy of the file to modify the metadata. This could involve a drawback similar to the one described at the beginning for the system of U.S. Pat. No. 6,363,356, which consists of recompiling the program to generate a wrapper (although in this case the drawback would be less because making a copy of a file is a much faster process than recompiling a program in a new file).

In any modern operating system, such as Microsoft Windows Server 2003 for example, moving a file from one directory to another in the same disc is a virtually instantaneous process which simply requires slightly modifying the directory structure. This process of moving a file is much faster than creating a copy of the file in the moment of the download.

It is therefore suitable for the download management application 40 to have several copies of the files 1 prepared beforehand, and it can adapt the number of copies of each particular file 1 according to the download statistics of the file. Making copies can be optimized by optionally using RAM memory based discs, in addition to having the mentioned already prepared copies ready to be sent.

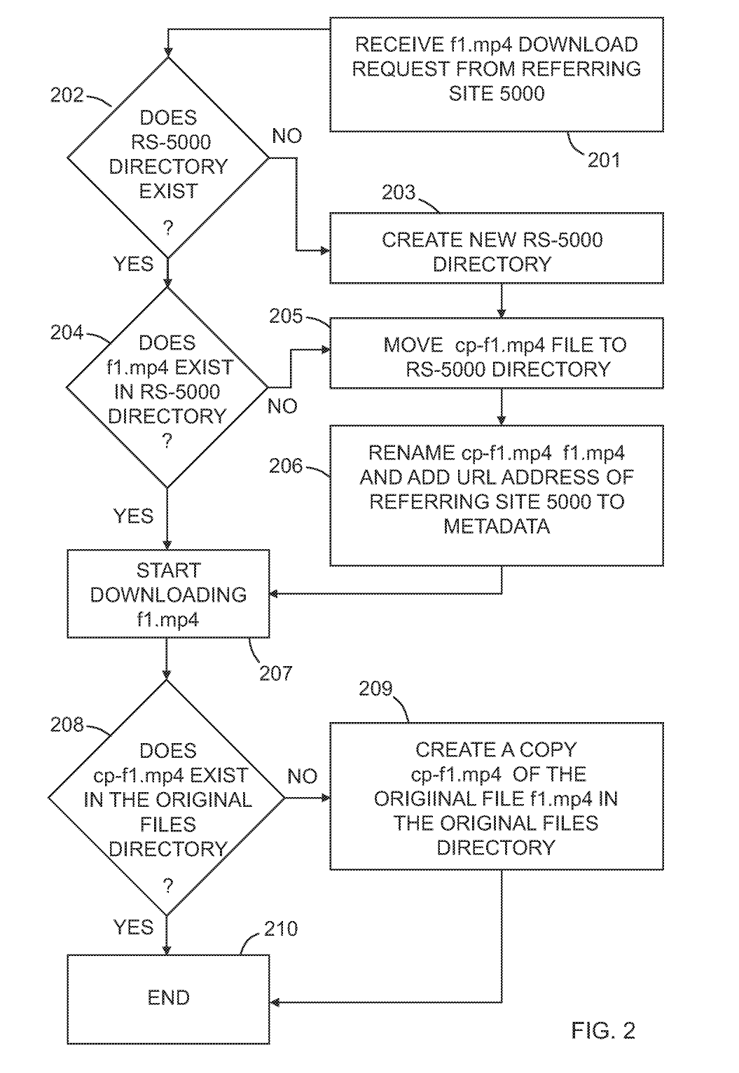

A process of executing a download management application 40 in one implementation is illustrated in further detail in FIG. 2. According to the previously explained example, a user has accessed the referring site 9 number 5,000 and has actuated the link 100 to download the file 1. As a result, the download management application 40 in the download sites 4 receives 201a download request to download the file 1, as previously explained, and checks 202 if there is in a hard drive of the download sites 4 a directory attributed to referring site 9 number 5,000. If there is not, it creates 203 the directory, which for example is called RS-5000 and which is associated to the URL address http://www.download-site.com/referring-site-5000. If there is, it checks 204 if the directory contains the file 1, which in this example is called f1.mp4. If the directory does not contain the file, or if the directory has just been created 203, it moves 205 to the directory RS-5000 one of the copies of the original file 1 which is stored in an original file directory containing the files delivered by the intermediary site 2. The copy of the original file 1 is called, for example, cp-f1.mp4. Then 206 it renames the file cp-f1.mp4, attributing it the same name as the original file f1.mp4 and copies in the URL9 label of the metadata of the file f1.mp4 the URL address of the referring site 9. As previously explained, the URL address of the referring site 9 was previously received by the download management application 40 as a parameter of the URL address contained in the link which was activated in the referring site 9. Once this information has been copied in the URL9 label of the metadata of file f1.mp4, downloading the file in the computer of the user begins 207. The download management application 40 then checks 208 if there are reserve copies of the original file 1, i.e. it checks if in the original file directory there is any file called cp-f1.mp4. If there is not, it creates 209 one or several copies cp-f1.mp4 of the original file f1.mp4 in the original file directory. If the copy of the file already existed, or after having created it, the algorithm ends 210.

Returning to FIG. 1, once the user has downloaded the files 1, the files can be used in a user's computer 5, specifically in an application which is an audiovisual player 52.

In some implementations the intermediary site 2 has a user registration system 26 comprising a Web interface so that users can register and give their personal data and other data suitable for selecting the advertising, such as for example their sex (male, female) their age or their hobbies. During this registration process, the user may choose an access code, such as for example his e-mail address and a password. The user can thus access his data stored in the intermediary site 2 and modify it. The intermediary site 2 can benefit registered users, for example allowing them to play the higher quality or novel contents only for registered users or by sending them less advertising than to non-registered users. When a user registers from the Internet browser 50 of a computer 5 connected 152 to the intermediary site 2, the intermediary site sends to the user's computer 5 a cookie-type file or the like 25 which allows automatically identifying the user without the user having to introduce his access code and password every time the computer 5 communicates with the intermediary site 2. As a person skilled in the art knows, a cookie is a fragment of information which is stored in the hard drive of the visitor of a webpage through his browser, upon request of the webpage server, and which can be retrieved by the server in subsequent visits to the page.

In some implementations the intermediary site 2 makes a selection of the most suitable advertisements for each audiovisual content. To that end, i some implementations the intermediary site 2 has an on-line advertisement auction management module 28, in which the different advertiser sites 8 can offer different prices for their advertisements for certain audiovisual content categories, for example black and white movies, or for a specific audiovisual content, for example the movie “Casablanca”.

The advertisements which have been selected by the intermediary site 2 can be inserted in the files 1 by the actual intermediary site 2 before sending the files to the download site 4, and they can also be inserted by the download site 4. In FIG. 1, the advertisements which are inserted by the intermediary site 2 have reference 22, whereas those which are inserted by the download site 4 have reference 23. In the event that the advertisements 23 are inserted by the download site 4, the intermediary site 2 transmits to the download site 4 a file containing the advertisements 23. This transmission of advertisements 23 from the intermediary site 2 to the download site 4 can be done every so often, for example every hour, every day, every week, etc. This allows the intermediary site 2 to periodically update the advertising which is to be advertised for each file 1. The intermediary site 2 can alternatively send to the download site 4 new complete files 1 containing the new advertisements, even though this solution involves greater bandwidth consumption.

In some implementations the users' equipment 5 are equipped with an audiovisual player 52 and an advertising management system 53, according to the invention, which cooperates with the player 52. The system 53 according to the invention takes care of the fact that the advertisements which are associated to playing the audiovisual content contained in the files 1 are shown. The system 53 allows the user to see the audiovisual content of the files 1 by means of the audiovisual player 52 only if the advertisements which were provided have been shown. As will be seen below, the advertisements can be shown in the form of videos taking up all or part of the screen 54 of the audiovisual player 52, or in the form of text or images which are superimposed on the audiovisual content, or even in the form of audio or in other forms.

FIG. 1 shows a solution in which the system 53 forms part of the audiovisual player 52. However, other solutions are possible: the system 53 can be, for example, an application which is executed in the operative system 51 of the computer 5 and which does not form part of the audiovisual player 52; it can also be an integral part of the actual operative system 51 or it can even be an external apparatus connected to the computer 5.

Another function of the system 53, in addition to allowing the audiovisual content of the files 1 to be played only if the associated advertisements which were provided have been shown, is to communicate to the intermediary site 2 the necessary information so that the intermediary site can bill the advertiser sites 8 for the advertisements which were actually shown in the users' players 52. Based on this billing, the intermediary site 2 can correspondingly remunerate the proprietary content sites 3 for playing the audiovisual content taking place in each audiovisual player 52.

To that end, in some implementations the system 53 communicates on-line 152 with the intermediary site 2 and sends it play information data 27 which allow identifying which advertisements associated to the audiovisual content have been shown together with the playing of such content. The play information data 27 can simply contain the identifier 16 which had been added to the file 1 by the intermediary site 2 before the download. In this case, when the intermediary site 2 receives from the system 53 the identifier 16 of the file 1 it knows, because it has stored this information in its database 21, which of the advertisements were comprised in the file 1 and associated to the audiovisual content of the file and, therefore, which ones have been shown in the audiovisual player 52. The play information data 27 preferably contains data individually identifying each advertisement and which have been introduced in the file 1 in the form of, for example, metadata by the intermediary site 2 or by the download site 4, together with the advertisements 22, 23. Therefore, the system 53 individually informs the intermediary site 2 of each advertisement 22, 23 that has been shown.

Furthermore, in some implementations the system 53 also communicates to the intermediary site 2 the download identifying data 14, 19 which had been included in the file 1 in the form of, for example, metadata before downloading the file 1, by the intermediary site 2 or by the download site 4. The system 53 obtains this downloaded identifying data 14, 19 by simply reading them in the file 1. As previously explained, in some implementations, only the data 19 (identifying data of the referring site 9) and not data 14 (identifying data of the download site 4) are included in the file 1 as download identifying data; in this case the system 53 may only communicate data 19 to the intermediary site 2. However, in some implementations, as shown in FIG. 1 the download identifying data which are inserted in the file 1 and then communicated to the intermediary site 2 by the system 53 are data 14 and data 19.

This download identifying data 14, 19 allows the intermediary site 2 to remunerate the referring sites 9 and the download sites 4 for the participation of the latter in downloading the file 1 which has led to the audiovisual content of the file being played and to the advertisements associated thereto being shown. The advantage of this system is that the referring sites 9 and the download sites 4 will only remunerate the downloads which have actually led to the audiovisual content of the files 1 being played and to the advertisements associated thereto being shown. It can be provided that the intermediary site 2 remunerates the download sites 4 and the referring sites 9 only the first time the audiovisual content of the files 1 downloaded in a player 52 is played, or that it remunerates them on the number of times the audiovisual content is played in each player 52.

Preferably, in the moment in which the user requests playing the audiovisual content of a file 1 in the player 52, the system 53 communicates 152 with the intermediary site 2 to update the advertisements associated to the audiovisual content which must be shown together with the playing of such content. To that end, the system 53 communicates 152 with the intermediary site 2 and transmits it updating data 17 including at least information which allows identifying the audiovisual content of the file 1. This information can be, for example, the mentioned identifier 16 of the file 1. The intermediary site 2 thus identifies the audiovisual content which is going to be played in the player 52 and decides if the advertisements 22 or 23 which were incorporated in the file 1 are suitable and if it is necessary to download other advertisements. This decision is made by the application 20 of the intermediary site 2 taking different factors into account. The factors which the application 20 particularly takes into account are the following:
If the campaigns of the advertiser sites 8 which had provided the advertisements 22 or 23 incorporated to the downloaded file 1 are still active.
If there are new advertiser sites 8 willing to pay a higher price for advertisements associated to the audiovisual content of the file 1. As previously mentioned, in some implementations the intermediary site 2 has an on-line advertisement auction management module in which the different advertiser sites 8 can offer different prices for their advertisements.

The update data 17 also preferably contains unique identifying data of the equipment 5 in which the audiovisual content is going to be played and/or of the user of the computer 5. This unique identifying data can be based, for example, on the serial number of the hard drive of the computer 5, the MAC (Media Access Control Address) address of the network card of the computer 5, the cookie 25 stored in the computer 5, or on any other data which allows identifying the computer 5 and/or the user of the computer 5. Thanks to this unique identifying data, the intermediary site 2 stores in its database 21 the information of the different audiovisual contents that the user downloads and plays in the audiovisual player 52. This information stored in the database 21 allows the intermediary site 2 to create a profile for each user, both for registered users in the intermediary site 2 and for non-registered users. The intermediary site 2 can use this user information or user profile to send the most suitable advertising to each user. Therefore, as a result of the intermediary site 2 receiving the unique identifying data of the computer 5, in order to update the advertisements which will be shown when playing the audiovisual content of a file 1, the application 20 of the intermediary site 2 can take into account several factors relating to the computer 5, in addition to the previously mentioned factors. For example, the application 20 can take the following factors into account:
The available bandwidth of the user in that moment to download new advertisements to the computer 5 from the intermediary site 2. This information can be provided by the system 53, comprised in the update data 17.
The time elapsed from when the user downloaded the file 1. This information can also be provided by the system 53, comprised in the update data 17.

If the application 20 of the intermediary site 2 decides that it is necessary to incorporate new advertisements 24 so that they are shown when playing the audiovisual content of a file 1, it transmits these advertisements 24 on-line to the system 53. It can also transmit in the file containing the advertisements 24 metadata identifying them.

The application 20 of the intermediary site 2 can decide that some of the advertisements 22, 23 which were incorporated in the file 1 must be cancelled, i.e. they should not be shown when playing the audiovisual content of the file 1. The application 20 communicates this decision to the system 53 so that it takes this into account when playing the audiovisual content of the file 1.

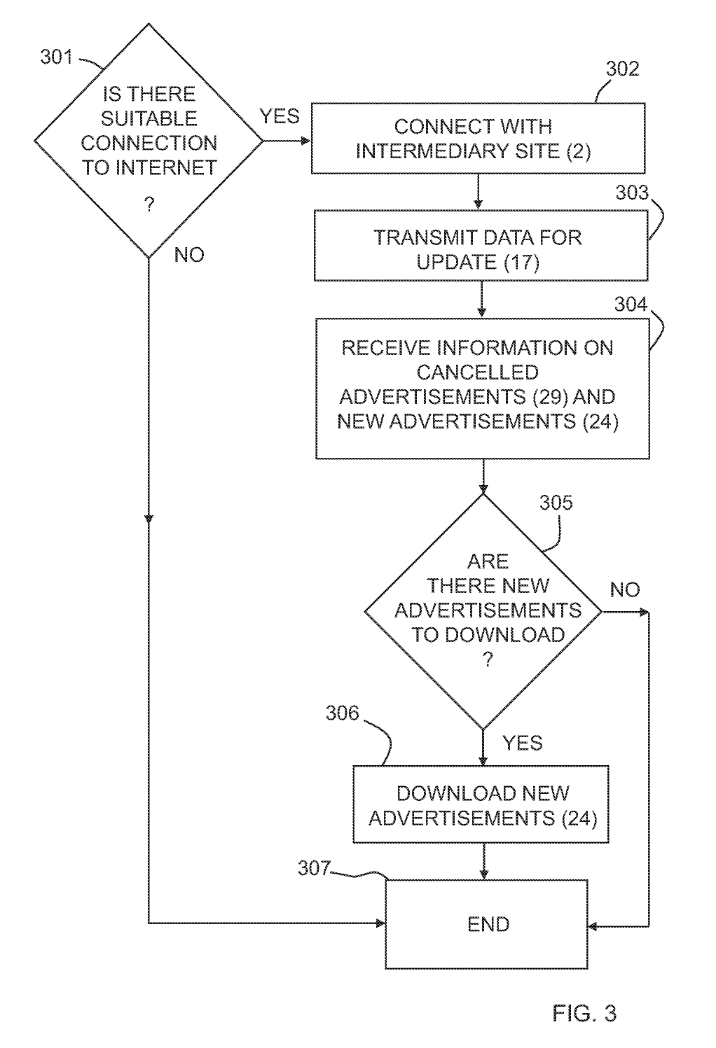

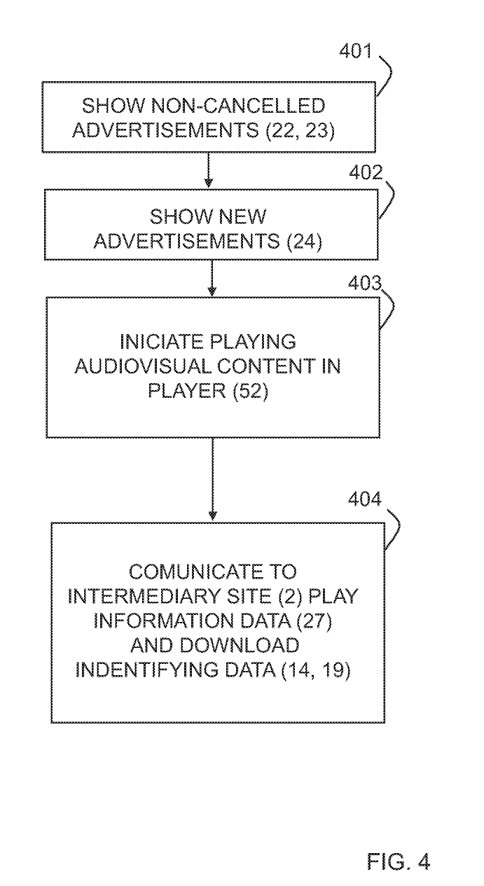

Exemplary processes executed in the system 53 for updating the advertisements and playing them in the player 52 are described below with the aid of FIGS. 3 and 4.

FIG. 3 shows a process executed by the system 53 for the intermediary site 2 to update the advertisements which must be shown. This process is executed when a user using the player 52 of the computer 5 commands it to play the audiovisual content of a file 1. First 301 the system 53 checks if the computer 5 has a connection to Internet that is suitable for downloading new advertisements from the intermediary site 2. If it does not, for example because the user has disconnected the connection to Internet after having downloaded the files 1 or because the available bandwidth is very low and would not allow downloading new advertisements 24, the process ends 307 and the system 53 then executes the process of playing the audiovisual content such as that shown in FIG. 4, which will be described below. In this case only the advertisements 22, 23 which were included in the file 1 will be shown. If it does, i.e. if the connection to Internet is suitable, the system 53 connects 302 with the intermediary site 2 and transmits to it the update data 17. As previously explained, based on this data 17 the application 20 of the intermediary site 2 decides if any of the advertisements 22, 23 which were included in the file 1 must be cancelled and if any new advertisement 24 must be included. The system 53 receives 304 from the intermediary site 2 information 29 on cancelled advertisements and on new advertisements, indicating if any of the advertisements 22, 23 must be cancelled and if it is necessary to download new advertisements 24. If there are new advertisements to be downloaded, 305 the system 53 downloads 306 the advertisements 24 after which the process ends 307. If not, the process directly ends without having attempted to download any new advertisement.

Once this process has ended, in some implementations the system 53 executes the process of FIG. 4 in order to show the advertisements and to play the audiovisual content of the file 1 using the player 52. First 401 the advertisements 22, 23 which were originally included in the file 1 and which have not been cancelled are shown in the player 52. Then 402 the new advertisements 24 which have been downloaded by the system 53 are shown in the player 52. In some implementations playing 403 the audiovisual content of the file 1 in the player 52 only begins if all the advertisements 22, 23 that have not been cancelled and all the new advertisements 24 which have been downloaded are shown. It can optionally be provided that the system 53 allows starting to play the audiovisual content without having shown all the advertisements, and showing the remaining advertisements during the playing or when such playing ends. In some implementations the system 53 stores information indicating which advertisements have been fully shown and communicates 404 to the intermediary site 2 the play information data 27, including an identification of the advertisements which have been shown, and the download data 14, 19 identifying the download sites 4 and the referring sites 9 which have participated in the process which led to downloading the file 1, as previously explained.

In some implementations the system 53 optionally takes into account the time elapsed from when a user downloaded a file 1 for the purpose of preventing that a process according to the invention generates a rejection by the users when they download new advertisements 24. For example, if a user downloads a file 1 and wishes to immediately play its audiovisual content, the user may become angry if he has to wait for new advertisements to be downloaded to see the content. In contrast, a user who downloads a file 1 and waits, for example, three months to play its content may more readily accept that the system 53 downloads new advertisements 24. To that end, the invention provides that the system 53 authorizes playing the audiovisual content of the file, downloads the new advertisements 24 while the audiovisual content is played and shows these new advertisements 24 once they have been downloaded. Preferably, before starting to play, the system 53 informs the user of the advertisements 22, 23, 24 which must be shown so as to authorize fully playing the audiovisual content, and the user can choose to see the advertisements before or while playing the audiovisual content.

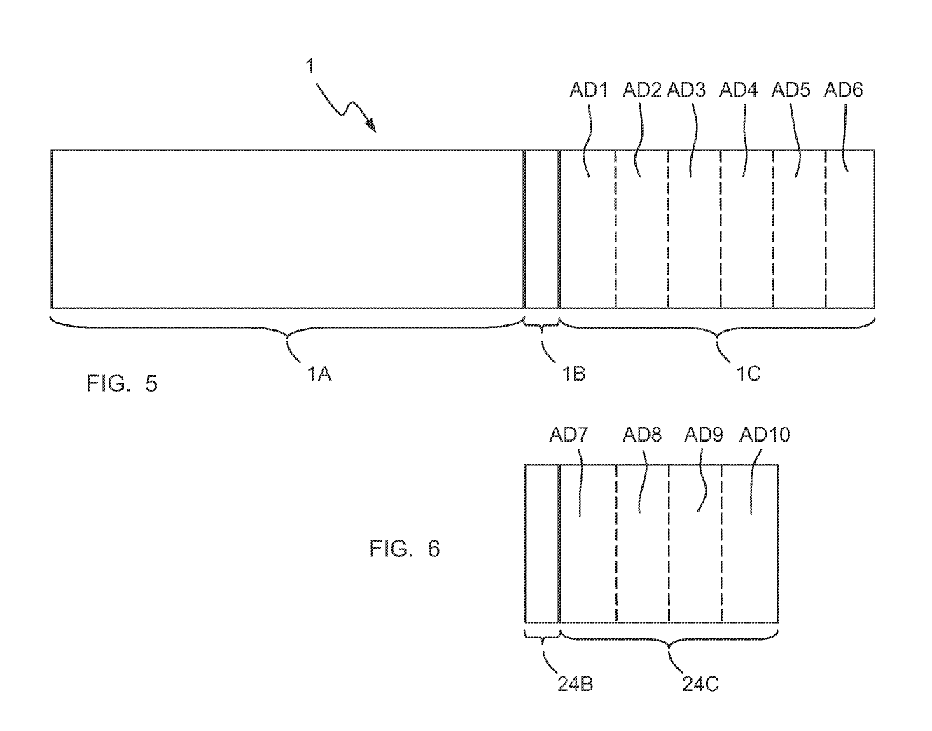

FIG. 5 shows an example of a file 1 with audiovisual content, which is downloaded in a user's computer 5. The file 1 contains a first part 1A with the audiovisual content, a second part 1B with metadata and a third part 1C with six advertisements AD1, AD2, AD3, AD4, AD5 and AD6 which have been inserted in the file 1 before it is downloaded in the computer 5. The metadata of the second part 1B contain the unique identifier 16 of the file 1, the identifying data of the advertisements contained in the file 1 and the download identifying data 14, 19. The six advertisements contained in part 1C of the file 1 can be the advertisements 22 (FIG. 1) which have been inserted by the intermediary site 2, or the advertisements 23 (FIG. 1) which have been inserted by the download site 4.

FIG. 6 shows an example of a file containing new advertisements and which is transmitted by the intermediary site 2 to the system 53. This file contains a first part 24B with metadata and a second part 24C containing 4 new advertisements: AD7, AD8, AD9 and AD10. These advertisements are the new advertisements 24 indicated in FIG. 1. The metadata of part 24B contains an indication of the advertisements contained in the file 1 which must be cancelled.

If, for example, the metadata of part 24B of the file of FIG. 6 indicates that advertisements AD2 and AD5 must be cancelled, the system 53 will only show advertisements AD1, AD3, AD4, AD6 (advertisements inserted in the file 1 before the download and which have not been cancelled) and advertisements AD7, AD8, AD9 and AD10 (new advertisements delivered by the intermediary site 2).

In the event that there are no new advertisements, part 24C of the file of FIG. 6 is empty and part 24B, in addition to possibly containing an indication of the advertisements of the file 1 which must be cancelled, also contains an indication that there are no new advertisements.

In some implementations, an optional improvement to prevent a user from being absent during the entire time in which the advertisements are shown is provided. This improvement consists of the fact that the system 53 cooperates with the audiovisual player 52 so that when the player has finished showing an advertisement, it waits to receive an indication from the user to begin to broadcast the following advertisement. Therefore, in order to see the audiovisual content, which in some implementations is only played when all the provided advertisements have been shown, the user must be present to indicate to the audiovisual player 52 to show each advertisement. In order for the user to give this indication, it can be provided for example that he pushes the play button of the audiovisual player 52. The system 53 preferably cooperates with the player 52 so that the latter does not show the audiovisual content of the file 1 if the time elapsed between the end of an advertisement and the moment in which the user clicks on the play button of the player 52 so that it shows the following advertisement exceeds a certain threshold. The user will thus pay attention to the advertisements in order to be able to act when each one of them ends.

In the embodiment described above, the system 53 may form part of the audiovisual player 52, i.e. the audiovisual player 52 is a player according to the invention which incorporates the system 53.

However, the invention also provides that the process according to the invention is compatible with the use of audiovisual players that do not incorporate the system 53, and that they can be audiovisual players according to the prior state of the art. To that end, a mechanism is necessary which allows the downloaded files to be seen in players from the prior state of the art and which guarantees that the users have seen the advertisements associated to the audiovisual content of the downloaded files.

A first solution consists of incorporating the advertisements to the audiovisual content, such that the advertisements are superimposed thereon. Therefore, when an audiovisual player from the state of the art plays the audiovisual content, it will also be playing the superimposed advertisements. For example, the advertisements can take up part of the screen in which the audiovisual content is played, or they can be text or graphic advertisements taking up the lower part of the screen. To that end, the intermediary site 2, the download site 5 and the system 53 are provided with an application which superimposes the advertisements on the audiovisual content. The way of performing such superimposition is within the scope of a person skilled in the art and it is therefore not considered necessary to describe it in further detail.

Another solution consists of the audiovisual content of the downloaded files being protected such that it can only be played if the system 53 authorizes it, and that the system 53 only authorizes playing it if it has been able to check that the user has seen the advertisements. In order to manage this authorization, the system 53 can use several methods, such as for example encrypting the content or using DRM technologies. A solution consists of the system 53 sending a message to the intermediary site 2 indicating that the advertisements have been shown in the computer 5, together with an identifier of the hardware of the computer 5, such as for example the serial number of the hard drive, and the intermediary site 2 sending back to the system 53 a message containing a key which allows the use of the content of the file but only in the computer 5. These types of protections or DRM technologies are widely known by a person skilled in the art.

Different techniques can be used in order for the system 53 to be able to check if the advertisements have been shown.

A first technique consists of the system 53 communicating with the audiovisual player in order to know the content that is being played. Some audiovisual players have specific development tools, such as for example the SDK (Software Development Kit) by Microsoft Media Player, which can be programmed to implement this communication. Another technique which can be used by the system 53 for performing the check consists of applying the technologies referred to as watermarking and perceptual hashing. Watermarking technology consists of adding to the audiovisual content marks that cannot be detected by the user, referred to as watermarks, which are detected when the content is played in an audiovisual player. Perceptual hashing technologies consist of generating a file, referred to as hash, which is different and unique for each audiovisual content played. These technologies are known by the person skilled in the art and it is therefore not considered necessary to explain them in further detail.

If a user does not have the system 53 installed in his computer when he attempts to play the audiovisual content of a downloaded file 1, the audiovisual player shows a message indicating to the user that it is necessary to install the system 53. This message is included in the downloaded file 1 and is the only part of the file 1 that the user can see if he does not install the system 53.

It can be seen that the process according to the invention is compatible with different downloading technologies, such as for example the BitTorrent file transfer protocol. In an embodiment of the invention, instead of directly downloading a complete file 1 from the download site 4, the user can download from the download site 4 a Torrent-type locator file, i.e. a file with a .torrent extension containing information which allows locating nodes on the Internet which have already downloaded the file 1 or parts thereof and which can be used as a source for downloading the file 1 in parallel from a plurality of the nodes. In this case, the metadata containing the download identifying data is incorporated as metadata of the Torrent file. The advertising management system 53 can read this metadata in the Torrent file. An alternative advantageous solution consists of a Torrent file download application being executed in the user's computer 5, reading the metadata in the Torrent file and included it as metadata in the file 1 which has been downloaded. This solution has the advantage that it allows doing away with the Torrent file once the download of the file 1 has been completed, whereby it is possible to use standard processes such as those described above, regardless of if the file 1 has been downloaded directly or by means of a locator file.

The processes according to the invention which have been described above with the aid of FIGS. 1 to 6 relate to a variety of ways of managing the advertisements according to which the file 1 which is downloaded in a user's computer 5 has advertisements 22, 23 incorporated therein, and in some implementations an advertising management system 53 sees to it that it is impossible to play the audiovisual content of the file 1 if the advertisements 22, 23 contained in the file 1 or the new advertisements 24 which the system 53 has downloaded from the intermediary site 2 are not shown in the actual audiovisual player 52.

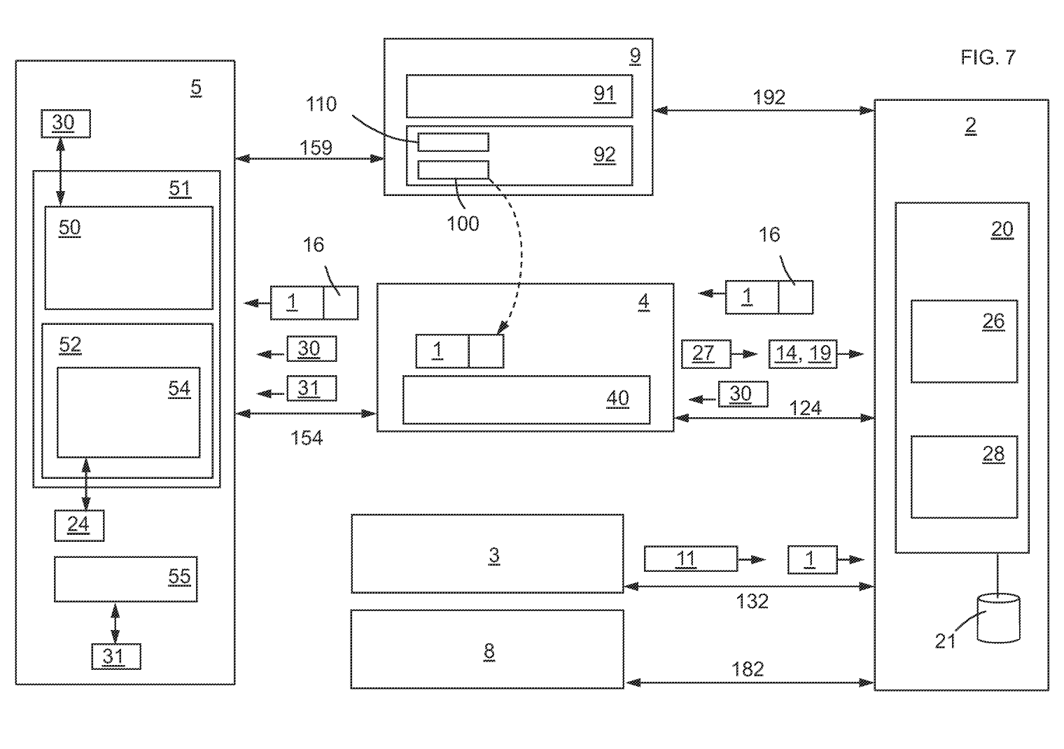

FIG. 7 illustrates an exemplary system useful for implementing other embodiments. Instead of being inserted in the file 1 which is downloaded in a user's computer 5, the advertisements are shown by the browser 50 of the computer 5 when it connects to the download site 4 to download the file 1. The download site 4 does not authorize downloading the file 1 as long as the advertisements have not been shown through the browser 50 in the computer 5. The processes according to these management forms is described below in further detail in reference to FIG. 7.

The same reference numbers have been used in FIG. 7 as those used in FIG. 1 to refer to the elements which are substantially the same.

The intermediary site 2 does not include the advertisements in the files 1 that it sends to the download site 4, but rather it separately delivers advertisements 30 associated to each file 1. When a user downloads one of these files 1 in the computer 5 using the browser 50 which is connected to the download site 4, the browser 50 shows the advertisements 30 associated to the file 1 and does not start to download the file 1 until the advertisements 30 have been shown in the browser 50. The advertisements 30 are preferably shown in the browser 50 using a streaming-type display technology, i.e. they are played in the screen of the computer 5 at the same time they are downloaded from the download site 4. Streaming-type display technologies are known by the person skilled in the art; they are implemented, for example, by applying the RTSP (Real Time Streaming Protocol) protocol. The advantage of using streaming-type technology is that the download site 4 knows when the advertisements 30 have been shown in the browser 50 of the computer 5 and only then will it allow the downloading of the file 1 to begin.

To prevent a user from being absent while the advertisements are shown in the browser 50, or canceling the effective display of the advertisements, for example by reducing the window of the browser 50, in some implementations the invention provides an improvement which consists of when the showing of an advertisement has ended, the user must interact with the computer 5 so that it begins to show the following advertisement. This can be done, for example, by making each advertisement a different streaming session and by making the user click on the play button of the player of the browser 50 so that each streaming session, i.e. so that the showing of each advertisement begins. The download site 4 preferably does not authorize downloading the digital file 1 if the time elapsed between the end of a streaming session and the moment in which the user clicks on the play button to indicate that it begin the following streaming session exceeds a certain threshold. The user will thus pay attention to the advertisements in order to be able to act when each one of them ends.

Once the advertisements 30 have been shown in the browser 50 and the file 1 has subsequently been downloaded in the computer 5, the download site 4 sends the download identifying data 14, 19 to the intermediary site 2, identifying the referring site 9 and the download site 4 which have contributed to downloading the file 1, and the play information data 27 which allow identifying which advertisements associated to the audiovisual content have been shown. As can be seen, in this case the data 27 and 14, 19 is sent to the intermediary site 2 by the download site 4, and not by the system 53 of the computer 5 as occurred in the process according to FIG. 1. It is therefore not necessary for the computer 5 to be equipped with a system 53 with these functionalities.

In order to prevent that the file 1 can be freely played after having been downloaded, the number of times the audiovisual content of the file 1 can be played and/or the time during which the audiovisual content can be played since the advertisements 30 were shown is limited. Furthermore, playing the audiovisual content of the file 1 is preferably only allowed in the computer 5 in which the advertisements 30 have been seen. To that end, a digital rights management or DRM system, which can be an application 55 installed in the computer 5, is used. The application 55 checks that in the computer in which the audiovisual content of the file 1 is going to be played there is a witness file which certifies that the advertisements 30 have been shown in the computer. This witness file can be for example a cookie 31 which has been transmitted to the computer 5 from the download site 4 or from the intermediary site 2 after the advertisements 30 have been shown. The application 55 will only allow playing the audiovisual content of the file 1 if it checks the existence of the witness file 31 in the computer 5. In the example shown in FIG. 7, the download site 4 sends the cookie 31 to the computer 5 when the display of the advertisements 30 by means of streaming in the browser 50 has ended.

In the example shown in FIG. 7, the application 55 is installed in the computer 5 and does not form part of the player 52. However, the invention also provides that the application 55 is integrated in the player 52 or in the browser 50. The application 55 can be, for example, a plugin for the browser 50.

In some implementations the download site 4 can choose between the various advertisement management forms, such as those described above in reference to FIGS. 1 and 7, depending on whether or not the computer 5 downloading the files 1 is provided with an advertising management system 53. If the computer 53 is provided with a system 53, the download site chooses the first advertisement management form according to FIG. 1, and in the event that it is not, it chooses the second way according to FIG. 7.

The advertising management system 53 (in the first advertisement management form according to FIG. 1) or the digital rights management application 55 (in the second advertisement management form according to FIG. 7) sees to it that a user cannot see the audiovisual content of the file 1 in another computer different from the computer 5 in which the file 1 has been downloaded if the user does not see the advertisements associated to the audiovisual content.

In order to choose between these two advertisement management forms, it is necessary for the download site 4 to know whether or not the computer 53 is provided with a system 53. To that end, the system 53 causes the creation of a cookie which is stored in the computer 5 and transmitted to the download site 4 when the computer 5 connects to the site download 4 to download a file 1. When the download site 4 receives a download petition to download a file 1 from the browser 50 of the computer 5, the cookie that was stored in the computer 5 is transmitted to the download site 4 and the site then knows that there is a system 53 installed in the computer 5 and chooses the first advertisement management form (FIG. 1). If the download site does not receive the cookie, it deduces that the computer 5 is not equipped with a system 53 and chooses the second advertisement management form (FIG. 7).

Cookies are created by Web servers and not by a computer application such as the system 53. In order for the system 53 to cause the creation of the cookie, the invention provides that the download site 4 has a webpage the purpose of which is to create the cookie, and that the system 53 accesses the webpage using the browser 50 of the computer 5. The system 53 does not create the cookie, rather it uses the browser 50 to access the webpage of the download site 4 which is who creates the cookie and sends it to the computer 5. The URL address of the webpage of the download site 4 forms part of the identifying data 14 of the download site 4 which is incorporated in the file 1.

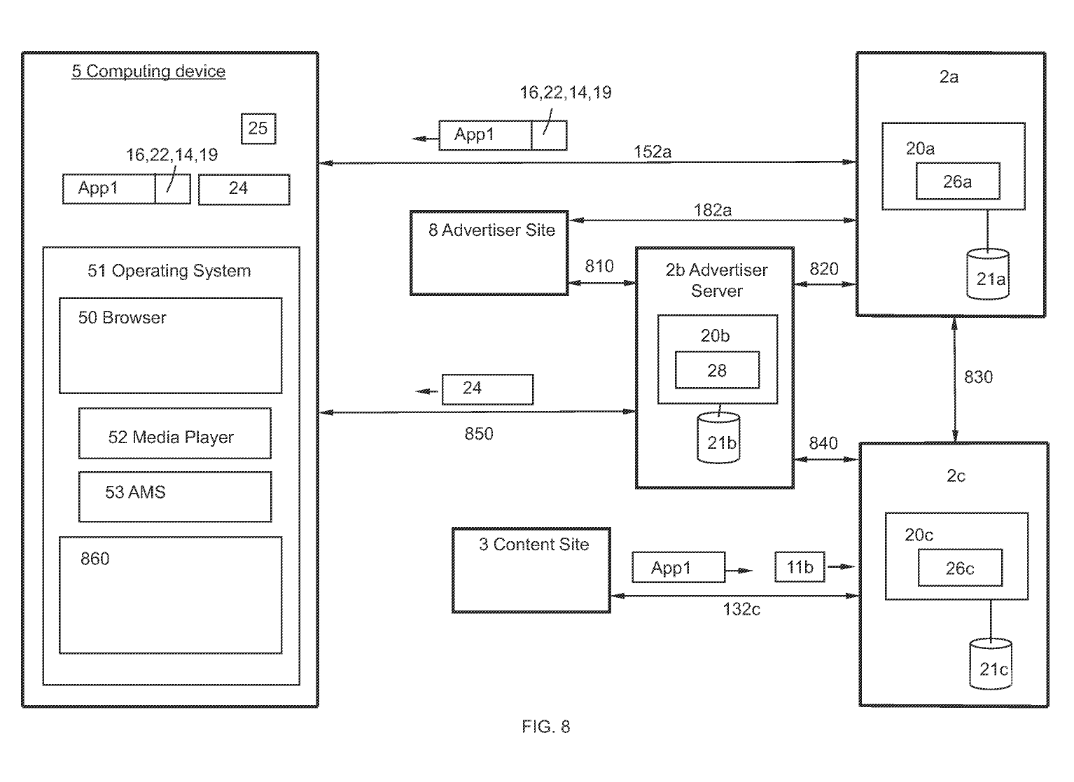

FIG. 8 illustrates an implementation in which the media player 52 and advertisement management system 53 are independent applications that run on the operating system 51 of computing device 5 and can communicate between each other. In other implementations the media player 52 and advertisement management system 53 are a part of a single application. In one implementation, the advertisement management system 53 is an integral part of operating system 51. In the example of FIG. 8 the functions of an intermediary site 2 have been distributed in three sites or servers 2a, 2b and 2c connected between each other by communications 820, 830 and 840. In other implementation the functions of the intermediary site are distributed between more or less than three sites or servers (e.g., 1, 2, 4, etc.).

As explained above, the download site 4 can be a separate site or may be part of the intermediary site 2. In the example of FIG. 8 the download site is part of site 2a and digital files may be downloaded directly from site 2a through communication 152a to computing device 5. In one implementation site 2a has an intermediating application 20a including an application 26a that allows for the online registration of users of computing device or computing devices 5. In one implementation the registration information is stored in a database 21a.

Although not shown, in one implementation the example of FIG. 8 comprises one or a plurality of referring sites that function in a manner similar to referring sites 9 disclosed in the previous implementations. For example, in some implementation a referring site is used to initiate the downloading of a file or files from site 2a. In such implementations a file to be downloaded or that is downloaded, can identify the referring site, for example, by including an identifier of the referring site as metadata 19 of the file.

In one implementation site 2b comprises an advertiser server. In one implementation the advertiser server comprises an intermediating application 20b and a module 28 of online Advertisement Auction Management through which advertisers may present different offerings for their advertisements. In one implementation site 2b stores such information in database 21b.

Although FIG. 8 shows a single advertiser site 8, other implementations may involve a plurality of advertiser sites 8. In one implementation an advertiser site 8 sends advertisements to site 2a through communication 182a or to the advertiser server 2b through communication 810. In one implementation site 2a relays advertisements received from an advertiser site 8 to advertiser server 2b through communication 820.

FIG. 8 also shows a site 2c that communicates with the content site 3 through communication 132c for the purpose of facilitating the receipt of file App1 and, in some implementations, commercial information 11b associated with file App1. In one implementation, site 2c has an intermediating application 20c and an application 26c which allows content providers to register on content site 3.

As explained above, the present invention is not limited to digital files with audiovisual content and can be applied to other types of digital files. For example, in one implementation digital file App1 comprises a software application.

In implementations comprising more than a single intermediary site, such as the example of FIG. 8, the plurality of sites (e.g., 2a, 2b, 2c) can exchange information and data, such as advertisement files, metadata about advertising, digital files, digital files containing advertisements and metadata, information on digital files, information received from the computing device 5 and any other type of information.

The following discloses an exemplary processes of transmitting a digital file App1 and advertisements 22 and 24 to a user computing device 5 and the playing advertisements in the user computing device to permit full use of the App1 application on computing device 5.

In one implementation content site 3 transmits to site 2c, on which the content site 3 has been registered, an App1 digital file (e.g., an application or software product for the purpose of being run on computing device 5). In one implementation content site also transmits commercial data 11b associated with the App1 application. In one implementation this information is stored in a database 21c of site 2c.

In one implementation advertisements received from one or more advertiser sites 8 are stored within a database 21b of advertiser server 2b. In one implementation the selection of advertisements to be matched with App1 application is accomplished by use criteria data included within information 11b. By use of this information, or other information, site 2b, or site 2b in conjunction with site 2a, may compare the criteria data with advertisement data to select the advertisements to be associated with the App1 application. In one implementation, after advertisement selection process is complete the advertiser server 2b transmits to site 2a the selected advertisements 22 to be associated with the digital file App1.

In one implementation, when site 2a receives the digital file App1 and the selected advertisements 22, a unique identifier 16 is generated (for example of a GUID type) or otherwise assigned which identifies the digital file App1 and/or the selected advertisements 22.

In one implementation, when site 2a receives a request from computing device 5 to download digital file App1, site 2a transmits to computing device 5 the digital file App1 along with metadata that comprises the identifier 16, and the selected advertisements 22. In one implementation this is accomplished by sending a single file, while in other implementations this is accomplished by sending multiple files.

When computing device 5 receives the digital file App1, which is an application or a software program, it installs the application so it can run on the operating system of computing device 5. In the example of FIG. 8, element 860 represents the software application App1 running on the operating system 51 of computing device 5.

In one implementation system 53 displays all or portion of the advertisements 22 associated with application 860 in the media player 52 before allowing a use, or full use, of the application 860 on computing device 5. In another implementation system 53 causes the advertisements to be played at some time after the execution of the application, such as, for example, intermittently during the execution of the application.

In one implementation, as explained above, system 53 may communicate, via communication 850, with the site 2b to receive additional or new advertisements 24 which can supplement or replace some advertisements 22 previously associated with digital file App1. The replacement or supplemental advertisements may be transmitted to the computing device at the time the digital file App1 is transmitted to the computing device or at a time thereafter. In one implementation replacement or supplemental advertisements are transmitted to the computing device 5 periodically, such as, for example, each time application 860 is run on the computing device 5. In other implementations, replacement or supplemental advertisements are transmitted to computing device 5 on a time basis (e.g., hourly, daily, weekly, etc.) or upon the occurrence of a planned or unplanned event.

User computing devices can avoid reproducing advertisements in different ways. One way is by installation of advertisement filtering software which functions to block access to certain servers and Internet equipment that are known to transmit advertising. Filtering is may be achieved by comparing the IP address, the URI (Uniform Resource Identifier), the IP address and port, or any other identifier of an advertisement source with a listing of known advertisement sources. Advertisement filtering software can be associated with one of the computing device applications, for example it may be a browser plug-in, or it may be an application running independently on computing device 5.

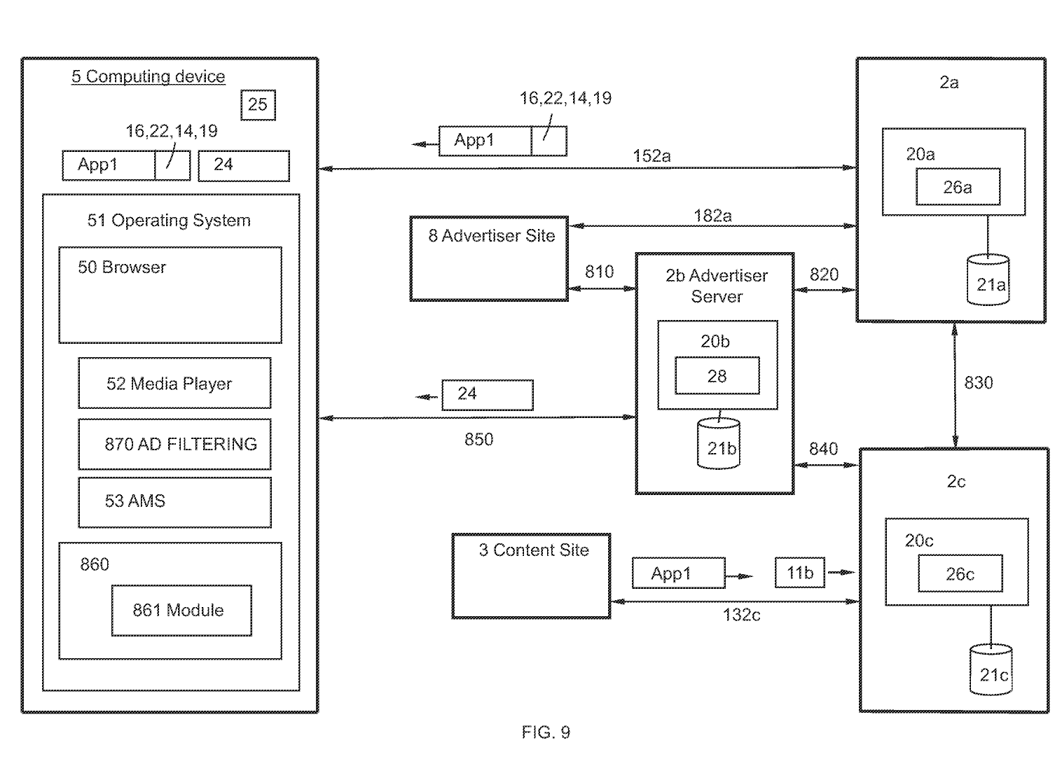

FIG. 9 shows an application 870 as a standalone advertisement filtering application that runs on the operating system 51 of computing device 5. This application 870 may comprise a list that is user configurable to include certain Internet advertisement servers. Certain forums exist on the Internet related to advertisement filtering programs such, for example, the Ad-Block Plus program.

Some advertisement filtering programs are open source programs and this allows companies with Internet advertiser servers to analyze the operation of the source code for the advertisement filtering programs in order to study the techniques used to block the advertisements and counter them. This tends to generate in a few days or months the launching of new versions of the advertisement filtering program that have been improved so as to counter the measures implemented by the companies and block the advertisements once again. An example of these ongoing changes can be seen in the forum of the Ad Block Plus program and the continual amendments to filter out advertising transmitted by the website www.hulu.com. Other advertisement filtering programs are commercial programs that do not publish their source code or publish their techniques used to filter advertising, such as the Ad-Muncher, making it difficult for companies with advertising servers to counter the measures of these commercial advertisement filtering programs.

Another way used to avoid advertisements is by means of altering or hacking part of the user's computing device. One example would be to hacking or altering the advertising management system 53 in charge of identifying the advertisements associated with the digital file App1 in a manner that improperly indicates that the advertisements have been reproduced in the computing device when in reality they have not.

Although some manufacturers try to block or limit the programs that users can install on their computers to restrict the way in which computers are used, to date manufacturers have not been very successful in preventing their equipment and operating systems from being continually hacked. There are programs like the famous “Jail Break” for iPhone that can eliminate these types of restrictions imposed by the device manufacturers.

In one implementation the problem of avoiding the reproduction/playing of advertisements on computing device 5 which are associated a digital file App1 involves including in the App1 application itself executable instructions that, when executed on the device, prevent application 860 from being fully executed when the advertising associated with the file App1 has not been properly played (e.g., skipped, partially skipped, not played, only partially played, deviates from an intended implementation of the advertisements, etc.) on the computing device. In one implementation the executable instructions prevents the use or full use of application App1 until the advertisements have been properly played or are being played on the computing device.

In one implementation the executable instructions are fully or at least partially implemented as a part of module 861 or component incorporated into the application or into a product comprising the application. A module or component may be a set of instructions which can be loaded in the memory of a computing device and incorporated in a software application/product to be executed together or in conjunction with the latter and provide specific functions. For example, module 861 may comprise a dynamic library, a class or set of classes, a control or class with a graphic interface, a set of functions, source code, compiled source code, semi-compiled source code, etc. and any combination thereof.

In one implementation, module 861 contains executable instructions that detects that no reproduction or an improper reproduction of the advertisements has occurred on computing device 5. In one implementation, upon such a detection the module 861 causes a delay that requires a user to wait for a time period at least as long as or longer than the time involved in playing the advertising associated with the application App1 before being able to use the App1 application. In this way it discourages the user from skipping the advertisements.

In one implementation, upon detecting that the user has not played an advertisement associated with App1, module 861 displays a message to the user, for example telling the user that the application App1 is financed by advertising and that the advertisements should or must be played. In one implementation the duration of the message is as long as or longer than the duration of the advertisements attempted to be avoided.

In one implementation at least a part of the executable instructions of module 861 are transmitted to the content site 3 from site 2c for the purpose of being incorporated with or in the App1 application. Content site 3 may be the App1 manufacture site or a site associated with the manufacturer. In one implementation the set of executable instructions is transmitted from site 2c in the form of a module or component. The module or component may comprise instructions which can be loaded in the memory of a computing device and incorporated in a software application/product to be executed together or in conjunction with the latter and provide specific functions. For example, module 861 may comprise a dynamic library, a class or set of classes, a control or class with a graphic interface, a set of functions, source code, compiled source code, semi-compiled source code, etc. and any combination thereof. In one implementation after the instructions have been incorporated with or in the App1 application, the App1 application with all or a portion of the instructions is transmitted to site 2c, or to a site associated with site 2c, where it is prepared for transmission to a user computing device.

In the same way that a hacker can modify system 53 to avoid reproducing the advertising on computing device 5, a hacker may also be able to alter or hack the applications themselves to annul the operation of module 861 and allow the use of application 860 on computing device 5 without playing the associated advertisements. There is however a difference between altering or “hacking” system 53 included in computing device 5 in order to manage the reproduction of advertising on computing device 5 and altering or hacking module 861 of the application App1. The difference is that for the same type of equipment or device, there may typically be a single application or API, which manages the playback of advertising associated with application software. However, there may be more than one hundred thousand applications available in site 2a developed by thousands of different software companies and each may implement the functionality of module 861 of the applications in a different way. This hinders the hacker's work as it is not enough to hack computing device 5 or system 53 just once. It also requires that each software application for which one wants to filter the advertising must also be hacked, thus multiplying by thousands the number of hours of hacker-work necessary to alter the applications that are downloaded from site 2a in a manner that enables them to be executed without reproducing the advertisements associated with each application.

There are several examples of download sites of applications that have tens or hundreds of thousands of applications, such as the online App Store by App1e or the Android Marketplace by Google.

The following provides some embodiments of module 861. One of the advantages of the present invention which makes the hacker's work more difficult is that each software content provider 3 may use a different or customized module 861 so as to require that each application downloaded by use of website 2a must be hacked differently. Therefore, the module 861 of each application can be a different or customized module for each application or each software company, for example by combining different embodiments that are explained below.

Different implementations of the present invention may use different cryptographic methods and/or algorithms that are explained below. Public-key cryptography is a cryptographic approach which involves the use of asymmetric key algorithms instead of or in addition to symmetric key algorithms. Unlike symmetric key algorithms, it does not require a secure initial exchange of one or more secret keys to both sender and receiver. The asymmetric key algorithms are used to create a mathematically related key pair: a secret private key and a published public key. Use of these keys allows protection of the authenticity of a message by creating a digital signature of a message using the private key, which can be verified using the public key. It also allows protection of the confidentiality and integrity of a message, by public key encryption, encrypting the message using the public key, which can only be decrypted using the private key.

Public key cryptography is a fundamental and widely used technology around the world. It is the approach which is employed by many cryptographic algorithms and cryptosystems. It underlies such Internet standards as Transport Layer Security (TLS) (successor to SSL), PGP, and GPG. The distinguishing technique used in public key cryptography is the use of asymmetric key algorithms, where the key used to encrypt a message is not the same as the key used to decrypt it. Each user has a pair of cryptographic keys—a public key and a private key. The private key is kept secret, whilst the public key may be widely distributed.

The two main branches of public key cryptography are:

Public key encryption: a message encrypted with a recipient's public key cannot be decrypted by anyone except a possessor of the matching private key—presumably, this will be the owner of that key and the person associated with the public key used. This is used for confidentiality.

Digital signatures: a message signed with a sender's private key can be verified by anyone who has access to the sender's public key, thereby proving that the sender had access to the private key (and therefore is likely to be the person associated with the public key used), and the part of the message that has not been tampered with.

An analogy for digital signatures is the sealing of an envelope with a personal wax seal. The message can be opened by anyone, but the presence of the seal authenticates the sender.

A central problem for use of public-key cryptography is confidence that a public key is correct, belongs to the person or entity claimed (i.e., is ‘authentic’), and has not been tampered with or replaced by a malicious third party. The usual approach to this problem is to use a public-key infrastructure (PKI), in which one or more third parties, known as certificate authorities, certify ownership of key pairs. Another approach, used by PGP, is the “web of trust” method to ensure authenticity of key pairs.

Examples of well-regarded asymmetric key techniques for varied purposes include:
Diffie-Hellman key exchange protocol
DSS (Digital Signature Standard), which incorporates the Digital Signature Algorithm
ElGamal
Various elliptic curve techniques
Various password-authenticated key agreement techniques
Paillier cryptosystem
RSA encryption algorithm (PKCS#1)
Cramer-Shoup cryptosystem

In cryptography, a public key certificate (also known as a digital certificate or identity certificate) is an electronic document which uses a digital signature to bind together a public key with an identity—information such as the name of a person or an organization, their address, and so forth. The certificate can be used to verify that a public key belongs to an individual.

In a typical public key infrastructure (PKI) scheme, the signature will be of a certificate authority (CA). In a web of trust scheme, the signature is of either the user (a self-signed certificate) or other users (“endorsements”). In either case, the signatures on a certificate are attestations by the certificate signer that the identity information and the public key belong together.

For provable security this reliance on something external to the system has the consequence that any public key certification scheme has to rely on some special setup assumption, such as the existence of a certificate authority.

Contents of a typical digital certificate generally comprise:
Serial Number: Used to uniquely identify the certificate.
Subject: The person, or entity identified.
Signature Algorithm: The algorithm used to create the signature.
Issuer: The entity that verified the information and issued the certificate.
Valid-From: The date the certificate is first valid from.
Valid-To: The expiration date.
Key-Usage: Purpose of the public key (e.g. encipherment, signature, certificate signing . . . ).
Public Key: The public key of the owner or subject of the certificate.
Thumbprint Algorithm: The algorithm used to hash the certificate.
Thumbprint: The hash itself to ensure that the certificate has not been tampered with.

Although the different embodiments explained below use public-key cryptography, with asymmetric key algorithms, the present invention may use other cryptography methods like symmetric key algorithms, certificates, etc.

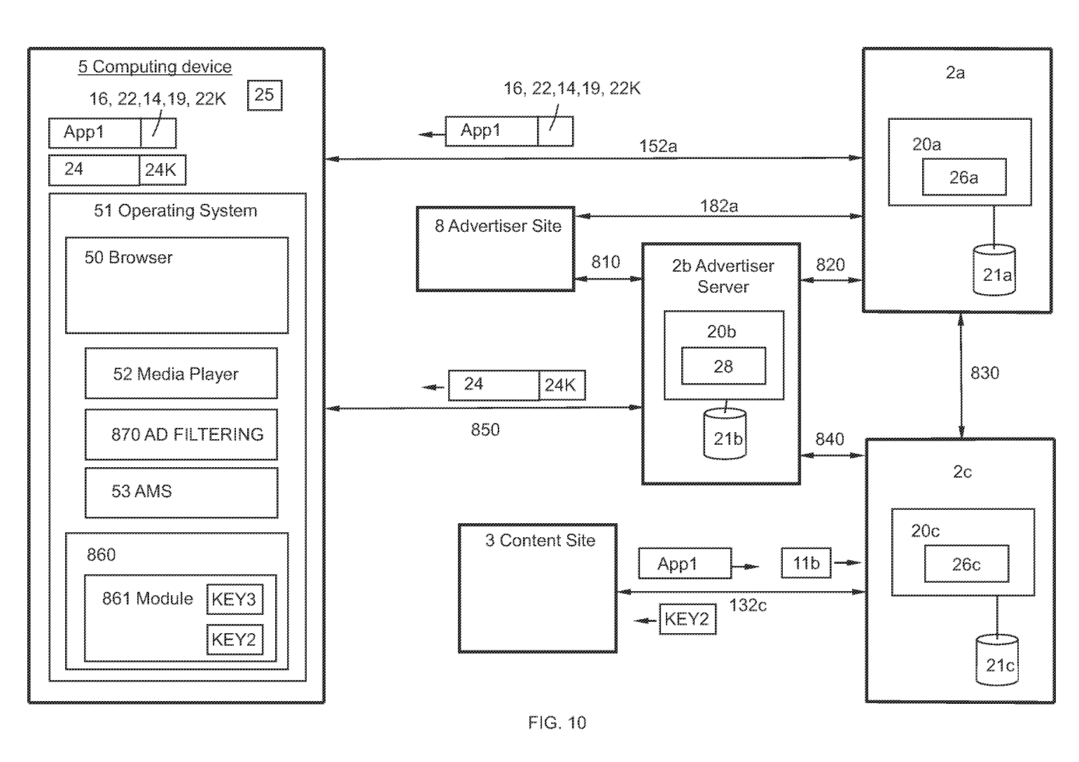

FIG. 10 illustrates an implementation using a private key and a public key KEY2 belonging to one or more of sites 2a, 2b and 2c. In one implementation the private key is used to create a digital signature associated with metadata 22K and/or 24K. The metadata 22K and 24K including information about the advertisements associated with the digital file App1. In one implementation the public key KEY2 is provided to the content provider to be incorporated into the module 861 of digital file App1.

The metadata 22K, 24K can be transmitted together with the advertisements 22, 24, in the same file containing the advertisements or in separate files. Metadata 22k and 24K may include, for example, one or more of the following:
1. App1 file name.
2. The trade name of application App1.
3. A single identifier of application App1.
4. The name of the software company that developed the application App1
5. A single identifier for the software company generated in site 2c upon registration.
6. A single identifier of the digital file App1 and the associated advertisements.
7. The number of advertisements associated with digital file App1.
8. The total time length of the advertisements associated with the digital file App1.
9. A single identifier for each advertisement linked to digital file 1 with information associated to each advertisement, such as the time in seconds, milliseconds, etc. of the playback length of each advertisement.
10. An expiration date for the metadata associated to the App1 file.
11. The name of the cryptographic algorithm used to generate electronic signatures.
12. A unique identifier of the cryptographic algorithm used to generate electronic signatures
13. An electronic signature of the metadata created with the private key corresponding to public key KEY2.

In one implementation, as shown in FIG. 10, the software content provider/site 3 receives the public key KEY2 through communication 132c after registering at the site 2c. Upon receiving the public key KEY2, the content provider incorporates, or otherwise integrates the public key into module 861 of application App1. Subsequently, when application 860 runs on computing device 5, the module 861 reads the metadata 22K and/or 24K of the advertisements associated with the digital file App1 and uses the public key KEY2 to check if the electronic signature of the metadata is correct.

In one implementation, to inhibit a hacker from altering on computing device 5 the cryptographic algorithm used to validate the electronic signature of the metadata 22K, 24K, the cryptographic algorithm is incorporated into module 861 in the form of executable instructions.

In one implementation, once application 860 has the advertisement information associated to the file App1, it calls up a function of system 53 which is responsible for showing the advertisements associated with the file App1, while concurrently, or at a different time, implementing a process to detect if system 53 and/or another part of computing device 5 has been altered to avoid reproducing all or a portion of the obligatory advertising.

In one implementation, a process for detecting if the advertisements have been properly reproduced involves checking that the playing time of the advertisements associated with the digital file App1 is equal to, substantially equal to, or similar to (for example, with a margin of 5%) the playback time specified in the metadata 22K, 24K. In one implementation, module 861 measures the playback time of advertisements using an internal clock of computing device 5. In another implementation module 861 measures the playback time of advertisements using a timer type variable which automatically increases by, for example, one every second or every millisecond.

In one implementation, if the playing time of the advertisements measured by use of module 861 coincides with the playing time indicated in the metadata, application 860 is permitted to run on computing device 5. If not, in one implementation module 861 causes a message to be displayed telling the user of the computing device 5 that the application 860 is advertisement-supported and that the associated advertisements must be played. In conjunction with or in lieu of displaying the message, the application 860 may be prevented from being run on computing device 5, or may be permitted to run with limited functionality. In one implementation, the duration of the displayed message is equal to or greater than the time of reproduction of advertisements. In one implementation module 861 allows the application 860 to run on computing device 5 after the message has been displayed.

In another implementation, module 861 uses a public key KEY3 that belongs to the software content provider/site 3, which has an associated private key. In this case the operation is similar to that described above but with the difference that the electronic signature of the metadata 22K, 24K is generated with the private key corresponding to public key KEY3.

In one implementation one or more of sites 2a, 2b or 2c send metadata 22K, 24K to content site 3 and content site 3 generates an electronic signature and forwards the signed metadata to one or more of sites 2a, 2b or 2c.

In another implementation, one or more of sites 2a, 2b and 2c know the private key corresponding to public key KEY3 of content provider 3 and the electronic signature of the metadata 22K, 24K is generated from one or more of sites 2a, 2b or 2c. In one implementation the key pair comprising the public key KEY3 and its corresponding private key is transmitted from one or more of sites 2a, 2b and 2c to content site 3, or a site associated with content site 3. In another implementation, the content provider receives a private key and a certificate containing the public key KEY3 from one or more of sites 2a, 2b and 2c which are used by the content providers to sign their applications to be marketed or otherwise distributed via one or more of sites 2a, 2b and 2c. In one implementation this certificate also includes a public key of one or more of sites 2a, 2b and 2c that can be used as the key KEY2 in the implementation disclosed above. In one implementation this involves the reuse of a certificate and a cryptographic key that already exists for the purpose of preventing or otherwise inhibiting computing device 5 from filtering advertisements associated with the applications financed through the advertisements.

In one implementation module 861 uses information from the metadata 22K or 24K available in computing device 5 itself to determine which advertisements are associated with the digital file App1. However, an advertisement filtering program, such as the 870 AD FILTERING program running on computing device 5, can filter all communications with the server 2b Advertiser Server to prevent computing device 5 from receiving the advertisements 24 and metadata 24K, which prevents the module 861 from knowing the advertisements 24 associated with the file App1.

The advertisement filtering program may also filter the advertisements 22 and metadata 22K when sent to computing device 5 if these data are transmitted in a particular form that the advertisement filtering program can filter, such as from a server that has a specific IP address or a specific URI or using a particular Internet port associated with an IP address, or a specific protocol such as XML. If advertisement filtering program, or the programmer which programs the advertisement filtering program, can detect how the advertisements 22, 24 and metadata 22K, 24K are transmitted to computing device 5, it can filter the transmission. The same problem occurs if the device has been altered or “hacked” to avoid the receipt of advertisements 22, 24 and metadata 22K, 24K, for example by altering the normal functioning of system 53.

In one implementation module 861 is equipped to detect that computing device 5 is filtering the communications used to transmit advertisements to computing device 5.

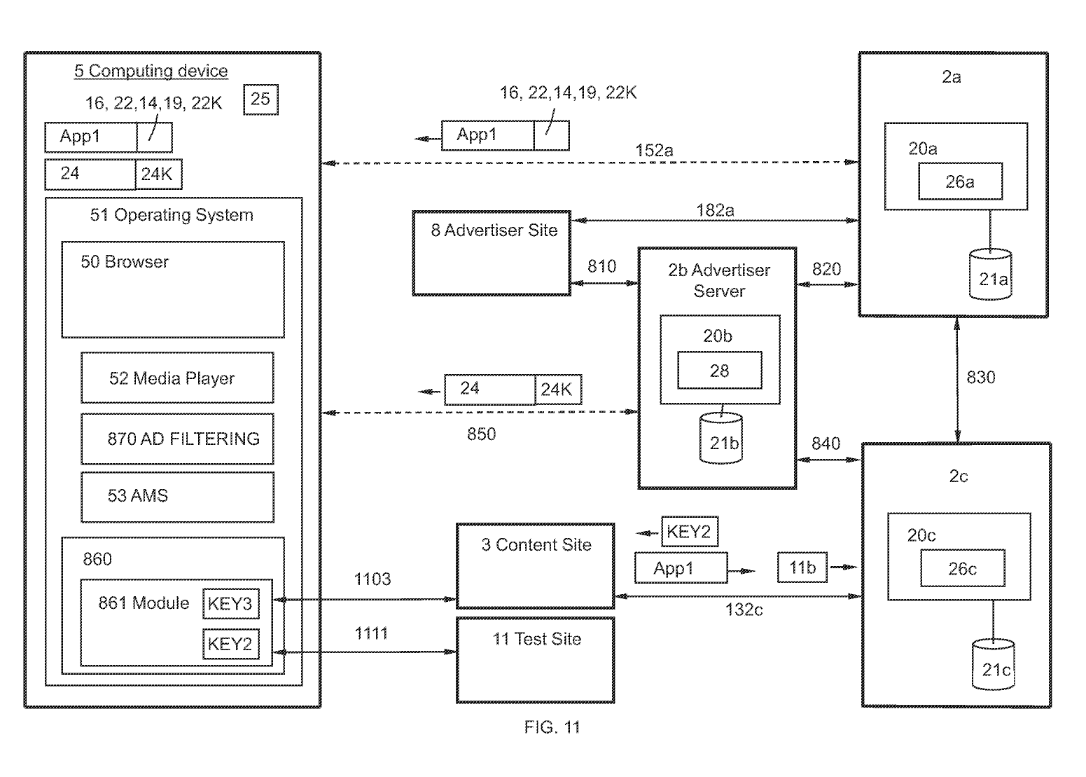

In FIG. 11, communications 850 and 152a (indicated by dashed lines) show that the transmission of the advertisements and/or the metadata 22, 24 to computing device 5 has been affected in a way that inhibits the transmission of the advertisements and/or metadata to the computing device. In one implementation when module 861 attempts to access the advertisements 22, 24 associated with the digital file App1 and/or metadata 22K, 24K, the module 861 finds that such information is not stored in computing device 5.

In one implementation module 861 executes instructions that are capable of determining or otherwise detecting if the communications 850 and 152a are impaired or are otherwise not functioning normally. In one implementation, module 861 checks whether the computing device 5 has access to the data network that connects computing device 5 with the sites 2a and 2b, such as the Internet.

Another way of checking if computing device 5 has access to the Internet is to establish communication with some well-known web site, such as www.google.com, www.yahoo.com, www.uspto.org, or any other well-known site. The URI of these sites may be stored in the module 861 itself and the communication 1111 may include, for example a simple message in the http protocol which causes a response from server 11.

If module 861 detects that there are no advertisemments associated with the application App1 stored on computing device 5, but that computing device 5 has an Internet connection that works, then when running the application 860 App1 on computing device 5, module 861 displays a message indicating, for example, that the application App1 is financed by advertising and asking the user to allow the downloading of the advertising. In one implementation, module 861 then finishes executing the application.

In one implementation, if module 861 detects that the device does not have access to the Internet, the module 861 displays a message, for example advising to get connection to the Internet to download the data needed to run the application and, in one implementation, it ends the execution of the application.

The preceding description includes numerous specific details that are selected solely for the purpose of illustrating some of many implementations of the present invention and not to limit the scope of the disclosure. It will be appreciated by one skilled in the art that the present invention is in no way limited to the implementations disclosed herein, but also includes other implementation, including any of a number of combination of implementations. As the ordinary person skilled in the art will easily understand, even though the implementations herein described relate to a computer, websites and webpages operating on the Internet, the invention can also be applied to other communications systems, such as for example a system acting in a communications network for cellular telephones or other similar devices. In this case, instead of a computer, the users use a cellular telephone to download and play the files with audiovisual content, and the different sites (intermediary site, referring sites, download sites, proprietary content sites and advertiser sites) operate in the communications network for cellular telephones.

What is claimed is:

1. A method comprising:
transmitting a digital file to a computing device upon receiving a request originating from the computing device to download the digital file to the computing device, the digital file comprising a set of executable instructions; and
transmitting one or more advertisements associated with the digital file to the computing device;
the set of executable instructions when executed in the computing device useable to detect if one or more of the associated advertisements have not been received or properly played in the computing device.

2. A method according to claim 1, wherein the set of executable instructions are useable to delay or to prevent or to inhibit full execution of the digital file in the computing device upon detecting that one or more of the associated advertisements have not been received or properly played in the computing device.

3. A method according to claim 1, wherein the one or more advertisements are transmitted to the computing device as a part of the digital file.

4. A method according to claim 1, wherein the digital file comprises a module, the set of executable instructions residing in the module.

5. A method according to claim 2, wherein the executable instructions are useable to delay the execution of all or a portion of the digital file in the computing device for a time period at least as long as or longer than the time involved in playing the associated advertisements.

6. A method according to claim 5, wherein the executable instructions are useable to create a display message in the computing device indicating to a user that the associated advertisements have not been received or properly played.

7. A method according to claim 1, wherein the executable instructions are useable to create a display message in the computing device indicating to a user that the associated advertisements have not been received or properly played.

8. A software application that is downloadable from a first site to a user computing device, full or unrestricted use of the software application in the user computing device requiring one or more advertisements associated with the software application to be played in the computing device, the software application comprising a module having executable instructions that when executed in the user computing device 1) accesses data related to the one or more advertisements from within the computing device or from the first site, 2) determines by use of the data if the one or more advertisements has been played in the computing device, and 3) inhibits full or unrestricted use of the software application in the computing device upon determining that less than the one or more advertisements have been played in the computing device.

9. A software application according to claim 8, wherein the data comprises a digital signature created by the use of a private key, the module comprising the public key associated with the private key.

10. A software application according to claim 9, wherein the module uses the public key to check if the electronic signature of the data is correct.

11. A software application according to claim 9, wherein the module includes an algorithm that validates the electronic signature of the data.

12. A software application according to claim 11, wherein the algorithm is a cryptographic algorithm.

13. A software application according to claim 9, wherein the public key originates from the first site.

14. A software application according to claim 8, wherein the executable instructions implement a process to detect if a part of the computing device has been altered to avoid playing the one or more advertisements.

15. A software application according to claim 8, wherein the data comprises play time information of the one or more advertisements and wherein the executable instructions are useable to delay an execution of all or a portion of the software application in the computing device for a time period at least as long as or longer than the time involved in playing the associated advertisements.

16. A software application according to claim 8, wherein the executable instructions are useable to create a display message in the computing device indicating to a user that the one or more advertisements must be played in the computing device upon determining that less than the one or more advertisements have been played in the computing device.

17. A software application according to claim 8, wherein the data comprises play time information of the one or more advertisements and wherein the executable instructions determine if the one or more advertisements have been properly played in the computing device by comparing the actual play time of the one or more advertisements with the play time information.

18. A method comprising:
transmitting a public key to a content provider to be incorporated into a software application, the public key associated with a private key;
receiving from the content provider the software application having the public key;
receiving from one or more advertisers a first one or more advertisements and associating the first one or more advertisements with the software application;
creating a first digital signature associated with first metadata that comprises information about the first one or more advertisements by use of the private key;
transmitting to a computing device the software application having the public key;
transmitting to the computing device the first one or more advertisements; and
transmitting to the computing device the digitally signed first metadata.

19. A method according to claim 18, wherein the software application and digitally signed first metadata are transmitted together to the computing device.

20. A method according to claim 18, wherein the software application, digitally signed first metadata and one or more advertisements are transmitted together to the computing device.

21. A method according to claim 18, wherein the digitally signed first metadata and the one or more advertisements are transmitted together to the computing device.

22. A method according to claim 18, further comprising associating a second one or more advertisements with the software application and transmitting to the computing device the second one or more advertisements after having transmitted to the computing device the first one or more advertisements.

23. A method according to claim 22, further comprising creating a second digital signature associated with second metadata that comprises information about the second one or more advertisements by use of the private key.

24. A method according to claim 23, further comprising transmitting to the computing device the digitally signed second metadata.

25. A method according to claim 24, wherein the second one or more advertisements and the digitally signed second metadata are transmitted together to the computing device.

26. A method according to claim 18, further comprising associating a second one or more advertisements with the software application, creating a digital signature associated with second metadata that comprises information about the second one or more advertisements by use of the private key and transmitting the second one or more advertisements and the digitally signed second metadata to the computing device after having transmitted to the computing device the first one or more advertisements.

27. A method according to claim 18, further comprising associating a second one or more advertisements with the software application, creating a digital signature associated with second metadata that comprises information about the second one or more advertisements by use of the private key and transmitting the second one or more advertisements and the digitally signed second metadata together in a single file to the computing device after having transmitted to the computing device the first one or more advertisements.

28. A method according to claim 18, wherein the software application is transmitted to the computing device from a first site and the first one or more advertisements are transmitted to the computing device from a second site different from the first site.

29. A method according to claim 18, wherein the software application and digitally signed first metadata are transmitted to the computing device from a first site and the first one or more advertisements are transmitted to the computing device from a second site different from the first site.

30. A method according to claim 18, wherein the software application is transmitted to the computing device from a first site and the first one or more advertisements and digitally signed first metadata are transmitted to the computing device from a second site different from the first site.

31. A method comprising:
receiving from an advertiser a first one or more advertisements and associating the first one or more advertisements with a software application;
creating a first digital signature associated with first metadata that comprises information about the first one or more advertisements by use of a private key;
transmitting a public key associated with the private key and a cryptographic algorithm useable to validate the first digital signature to a content provider to be incorporated into a software application;
receiving from the content provider the software application having the public key and the cryptographic algorithm;
transmitting to a computing device the software application having the public key and the cryptographic algorithm;
transmitting to the computing device the first one or more advertisements; and
transmitting to the computing device the digitally signed first metadata.

32. A method comprising:
transmitting from a first site executable instructions to a second site for the purpose of being incorporated into a software application, the first site different from the software application manufacturer site,
receiving in the first site, or a third site associated with the first site, the software application incorporating the executable instructions,
transmitting from the first site or the third site the software application incorporating the executable instructions to a user computing device,
transmitting from the first site and/or the third site and/or or a fourth site associated with one or both of the first and third sites, one or more advertisements associated with the software application to the user computing device, full or unrestricted use of the software application in the user computing device requiring one or more of the advertisements to be played in the computing device,
the executable instructions when executed in the user computing device 1) accesses data related to the one or more advertisements from within the computing device or from the first site and/or third site and/or fourth site, 2) determines by use of the data if the one or more advertisements has been properly played in the user computing device, and 3) inhibits full or unrestricted use of the software application in the user computing device upon determining that less than the one or more advertisements has been properly played in the user computing device.

33. A method according to claim 32, wherein the one or more advertisements are transmitted to the computing device as a part of the software application.

34. A method according to claim 32, wherein the one or more advertisements are transmitted to the computing device with the software application.

35. A method according to claim 32, wherein the software application comprises a module, the executable instructions residing in the module.

36. A method according to claim 32, wherein the executable instructions are useable to delay the execution of all or a portion of the software application in the computing device for a time period at least as long as or longer than the time involved in playing the associated one or more advertisements.

37. A method according to claim 36, wherein the executable instructions are useable to create a display message in the computing device indicating to a user that the associated one or more advertisements have not been properly played.

38. A method according to claim 32, wherein the second site is the software application manufacturer site or a site associated with the software application manufacturer.

39. A method according to claim 32, wherein the executable instructions comprise source code, compiled source code, semi-compiled source code or a combination thereof.
